(19) United States
(12) Patent Application Publication
(10) Pub. No.: US 2025/0317821 A1
(43) Pub. Date: Oct. 9, 2025

(54) LAYER 1 (L1) AND LAYER (L2) SIGNALING OF CELL AND/OR BEAM CHANGES

(71) Applicant: QUALCOMM Incorporated, San Diego, CA (US)

(72) Inventors: Fang YUAN, Beijing (CN); Yan ZHOU, San Diego, CA (US); Jelena DAMNJANOVIC, Del Mar, CA (US); Tao LUO, San Diego, CA (US)

(21) Appl. No.: 18/862,934

(22) PCT Filed: Jun. 2, 2022
(86) PCT No.: PCT/CN2022/096805

§ 371 Date: Nov. 4, 2024

Related U.S. Application Data
(63) Continuation of application No. PCT/CN2022/091133, filed on May 6, 2022.

(51) Int. Cl. H04W 36/08; H04L 5/00; H04W 36/00; H04W 56/00; H04W 80/02

(52) U.S. Cl. CPC H04W 36/08; H04L 5/0051; H04W 36/00835; H04W 56/0045; H04W 80/02

(57) ABSTRACT

Disclosed are systems and techniques for performing wireless communication. For example, a method for wireless communications at a network entity (e.g., a base station or portion thereof) may include selecting a special cell (SpCell) from one or more candidate cells for communicating with a user equipment (UE) and transmitting an indication of the SpCell to the UE. In another example, a method for wireless communications at a user equipment (UE) may include receiving an indication of a special cell (SpCell) from a network entity and, in response to the indication, communicating with the SpCell.

### CROSS-REFERENCE TO RELATED APPLICATIONS

This application for Patent is a 371 of international Patent Application PCT/CN2022/096805, filed Jun. 2, 2022, which claims priority to international Patent Application PCT/CN2022/091133, filed May 6, 2022, all of which are hereby incorporated by referenced in their entirety and for all purposes.

### FIELD OF THE DISCLOSURE

Aspects of the present disclosure generally relate to wireless communication. In some implementations, examples are described for signaling of cell and/or beam changes, such as Layer 1 (L1) and/or Layer 2 (L2) signaling of cell and/or beam changes.

### BACKGROUND OF THE DISCLOSURE

Wireless communications systems are deployed to provide various telecommunication services, including telephony, video, data, messaging, broadcasts, among others. Wireless communications systems have developed through various generations, including a first-generation analog wireless phone service (1G), a second-generation (2G) digital wireless phone service (including interim 2.5G networks), a third-generation (3G) high speed data, Internet-capable wireless service, a fourth-generation (4G) service (e.g., Long-Term Evolution (LTE), WiMax), and a fifth-generation (5G) service (e.g., New Radio (NR)). There are presently many different types of wireless communications systems in use, including cellular and personal communications service (PCS) systems. Examples of known cellular systems include the cellular Analog Advanced Mobile Phone System (AMPS), and digital cellular systems based on code division multiple access (CDMA), frequency division multiple access (FDMA), time division multiple access (TDMA), the Global System for Mobile communication (GSM), etc.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, methods, apparatuses, and computer-readable media for performing wireless communication. According to at least one example, a method for wireless communications performed at a network entity is provided. The method may include: selecting a special cell (SpCell) from one or more candidate cells for communicating with a user equipment (UE); and transmitting an indication of the SpCell to the UE.

In another example, an apparatus for wireless communications is provided that includes at least one memory comprising instructions and at least one processor (e.g., configured in circuitry) coupled to the memory and configured to: select a special cell (SpCell) from one or more candidate cells for communicating with a user equipment (UE); and transmit an indication of the SpCell to the UE.

In another example, a non-transitory computer-readable medium is provided that includes stored thereon at least one instruction that, when executed by one or more processors, may cause the one or more processors to: select a special cell (SpCell) from one or more candidate cells for communicating with a user equipment (UE); and transmit an indication of the SpCell to the UE.

In another example, an apparatus for wireless communication is provided. The apparatus may include: means for selecting a special cell (SpCell) from one or more candidate cells for communicating with a user equipment (UE); and means for transmitting an indication of the SpCell to the UE.

According to at least one other example, a method for wireless communications performed at a user equipment (UE) is provided. The method may include: receiving an indication of a special cell (SpCell) from a network entity; and in response to the indication, communicating with the SpCell.

In another example, an apparatus for wireless communications is provided that includes at least one memory and at least one processor (e.g., configured in circuitry) coupled to the memory and configured to: receive an indication of a special cell (SpCell) from a network entity; and in response to the indication, communicate with the SpCell.

In another example, a non-transitory computer-readable medium is provided that includes stored thereon at least one instruction that, when executed by one or more processors, may cause the one or more processors to: receive an indication of a special cell (SpCell) from a network entity; and in response to the indication, communicate with the SpCell.

In another example, an apparatus for wireless communication is provided. The apparatus may include: means for receiving an indication of a special cell (SpCell) from a network entity; and means for, in response to the indication, communicating with the SpCell.

According to at least one other example, a method for wireless communications performed at a user equipment (UE) is provided. The method may include: receiving, from a first special cell (SpCell), a beam indication or activation command via a medium access control-control element (MAC-CE) or a downlink control element (DCI); and in response to the beam indication or activation command, determining a second SpCell for communication.

In another example, an apparatus for wireless communications is provided that includes at least one memory and at least one processor (e.g., configured in circuitry) coupled to the memory and configured to: receive, from a first special cell (SpCell), a beam indication or activation command via a medium access control-control element (MAC-CE) or a downlink control element (DCI); and in response to the beam indication or activation command, determine a second SpCell for communication.

In another example, a non-transitory computer-readable medium is provided that includes stored thereon at least one instruction that, when executed by one or more processors, may cause the one or more processors to: receive, from a first special cell (SpCell), a beam indication or activation command via a medium access control-control element (MAC-CE) or a downlink control element (DCI); and in response to the beam indication or activation command, determine a second SpCell for communication.

In another example, an apparatus for wireless communications is provided that includes: means for receiving, from a first special cell (SpCell), a beam indication or activation command via a medium access control-control element (MAC-CE) or a downlink control element (DCI); and means for, in response to the beam indication or activation command, determining a second SpCell for communication.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 is a block diagram illustrating an example of a wireless communication network, in accordance with some examples;

FIG. 2 is a diagram illustrating a design of a base station and a User Equipment (UE) device that enable transmission and processing of signals exchanged between the UE and the base station, in accordance with some examples;

FIG. 3 is a diagram illustrating an example of a disaggregated base station, in accordance with some examples;

FIG. 4 is a block diagram illustrating components of a user equipment, in accordance with some examples;

FIG. 5 illustrates an example of a single primary serving cell (PCell) change without carrier aggregation, in accordance with some examples;

FIG. 6 illustrates an example of a PCell and secondary serving cell (SCell) change with carrier aggregation, in accordance with some examples;

FIG. 7 illustrates an example of cell group based selection, in accordance with some examples;

FIG. 8 illustrates an example of preconfigured candidate cells for L1/L2 based special cell (SpCell) change, in accordance with some examples;

FIG. 9 illustrates another example of preconfigured candidate cells for L1/L2 based SpCell selection, in accordance with some examples;

FIG. 10 illustrates an example of SpCell selection, in accordance with some examples;

FIG. 11 illustrates another example of SpCell selection, in accordance with some examples;

FIG. 12 illustrates another example of SpCell selection, in accordance with some examples;

FIG. 13 is a diagram illustrating an example of a slot boundary of an application time being determined by a slot boundary of an old cell, in accordance with some examples;

FIG. 14 is a diagram illustrating an example of a slot boundary of an application time being determined by a slot boundary of a new cell, in accordance with some examples;

FIG. 15 is a diagram illustrating an example of a beam indication based cell change and acknowledgement, in accordance with some examples;

FIG. 16 is a diagram illustrating an example of different octets in a medium access control (MAC) control element, in accordance with some examples;

FIG. 17 is a diagram illustrating an example of a case where a same cell identifier or identity (ID) space is used for both candidate cell changes and cell changes for channel assignment, in accordance with some examples;

FIG. 18 is a diagram illustrating an example of using a separate cell ID space for candidate cell changes and cell changes for channel assignment, in accordance with some examples;

FIG. 19 is a diagram illustrating an example of a unified Transmission Configuration Indicator (TCI) state activation/deactivation MAC control element, in accordance with some examples;

FIG. 20 is a diagram illustrating an example of a beam indication based cell change and acknowledgement, in accordance with some examples;

FIG. 21 is a diagram illustrating an example of a unified TCI state activation/deactivation MAC control element, in accordance with some examples;

FIG. 22 is a diagram illustrating an example of a case where a same cell ID space is used for both candidate cell changes and cell changes for channel assignment, in accordance with some examples;

FIG. 23 is a diagram illustrating an example of a unified TCI state activation/deactivation MAC control element, in accordance with some examples;

FIG. 24 is a diagram illustrating an example of a case where a separate cell ID space is used for both candidate cell changes and cell changes for channel assignment, in accordance with some examples;

FIG. 25 is a diagram illustrating an example of pseudo-code for a cross carrier scheduling configuration, in accordance with some examples;

FIG. 26 is a diagram illustrating an example of a downlink (DL) bandwidth part (BWP) field in a MAC control element, in accordance with some examples;

FIG. 27 is a diagram illustrating an example of a TCI updating downlink control information (DCI) in an old SpCell, in accordance with some examples;

FIG. 28 is a diagram illustrating an example of a case where a separate cell ID space is used for both candidate cell changes and cell changes for channel assignment, in accordance with some examples;

FIG. 29 is a diagram illustrating an example of simultaneous scheduling plus SpCell switching, in accordance with some examples;

FIG. 30 is a diagram illustrating an example of cells for a channel assignment, in accordance with some examples;

FIG. 31 is a diagram illustrating an example of a cell group change in a channel assignment, in accordance with some examples;

FIG. 32 is a diagram illustrating an example of a cell change command application time, in accordance with some examples;

FIG. 33 is a diagram illustrating an example of options for application time based on a new cell or old cell slot boundary, in accordance with some examples; and

FIG. 34 is a block diagram illustrating an example of a computing system, in accordance with some examples.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

Wireless communication networks are deployed to provide various communication services, such as voice, video, packet data, messaging, broadcast, any combination thereof, or other communication services. A wireless communication network may support both access links and sidelinks for communication between wireless devices. An access link may refer to any communication link between a client device (e.g., a user equipment (UE), a station (STA), or other client device) and a base station (e.g., a 3GPP gNB for 5G/NR, a 3GPP eNB for 4G/LTE, a Wi-Fi access point (AP), or other base station). For example, an access link may support uplink signaling, downlink signaling, connection procedures, etc. An example of an access link is a Uu link or interface (also referred to as an NR-Uu) between a 3GPP gNB and a UE.

As described in more detail below, processes (also referred to as methods), and computer-readable media (collectively referred to as “systems and techniques”) are described herein for signaling of cell and/or beam changes, such as Layer 1 (L1) and/or Layer 2 (L2) signaling of cell and/or beam changes. Alternatively or in addition, in some aspects, the systems and techniques can provide Timing Advance (TA) and/or beam management (BM) for one or more deactivated serving cells.

Additional aspects of the present disclosure are described in more detail below.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), aircraft (e.g., an airplane, jet, unmanned aerial vehicle (UAE) or drone, helicopter, airship, glider, etc.) and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.) and so on.

A network entity can be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with UEs depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, or a forward traffic channel, etc.). The term traffic channel (TCH), as used herein, can refer to either an uplink, reverse or downlink, and/or a forward traffic channel.

The term “network entity” or “base station” (e.g., with an aggregated/monolithic base station architecture or disaggregated base station architecture) may refer to a single physical transmit receive point (TRP) or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals (or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

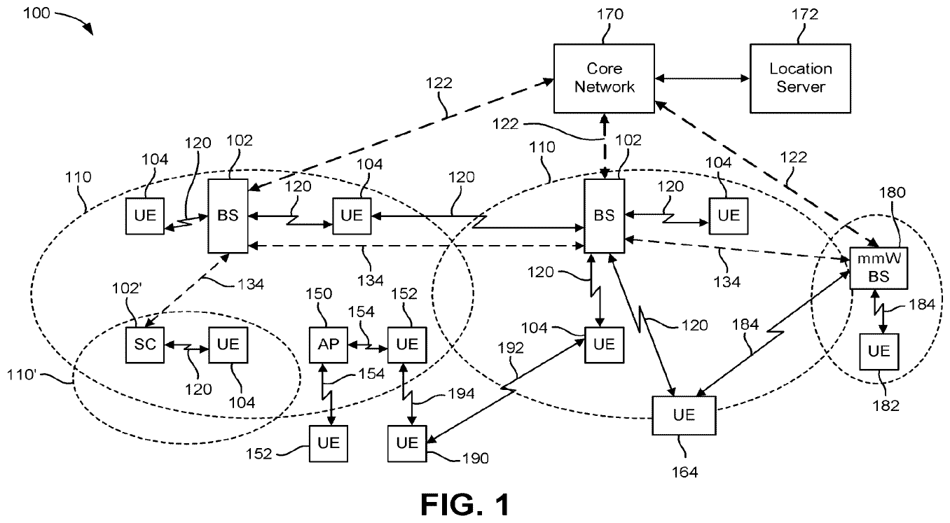

Various aspects of the systems and techniques described herein will be discussed below with respect to the figures. According to various aspects, FIG. 1 illustrates an example of a wireless communications system 100. The wireless communications system 100 (which may also be referred to as a wireless wide area network (WWAN)) can include various base stations 102 and various UEs 104. In some aspects, the base stations 102 may also be referred to as “network entities” or “network nodes.” One or more of the base stations 102 can be implemented in an aggregated or monolithic base station architecture. Additionally, or alternatively, one or more of the base stations 102 can be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 can include macro cell base stations (high power cellular base stations) and/or small cell base stations (low power cellular base stations). In an aspect, the macro cell base station may include eNBs and/or ng-eNBs where the wireless communications system 100 corresponds to a long term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identity or identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 can include devices (e.g., UEs, etc.) that communicate with one or more UEs 104, base stations 102, APs 150, etc. utilizing the ultra-wideband (UWB) spectrum. The UWB spectrum can range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHZ with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

In some aspects relating to 5G, the frequency spectrum in which wireless network nodes or entities (e.g., base stations 102/180, UEs 104/182) operate is divided into multiple frequency ranges, FR1 (from 450 to 6000 Megahertz (MHz)), FR2 (from 24250 to 52600 MHz), FR3 (above 52600 MHz), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation (CA), the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency and/or component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (x component carriers) for transmission in each direction. The component carriers may or may not be adjacent to each other on the frequency spectrum. Allocation of carriers may be asymmetric with respect to the downlink and uplink (e.g., more or less carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (e.g., 40 MHZ), compared to that attained by a single 20 MHz carrier.

In order to operate on multiple carrier frequencies, a base station 102 and/or a UE 104 can be equipped with multiple receivers and/or transmitters. For example, a UE 104 may have two receivers, “Receiver 1” and “Receiver 2,” where “Receiver 1” is a multi-band receiver that can be tuned to band (e.g., carrier frequency) ‘X’ or band ‘Y,’ and “Receiver 2” is a one-band receiver tuneable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (an SCell) in order to measure band ‘Y’ (and vice versa). In contrast, whether the UE 104 is being served in band ‘X’ or band ‘Y,’ because of the separate “Receiver 2,” the UE 104 can measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

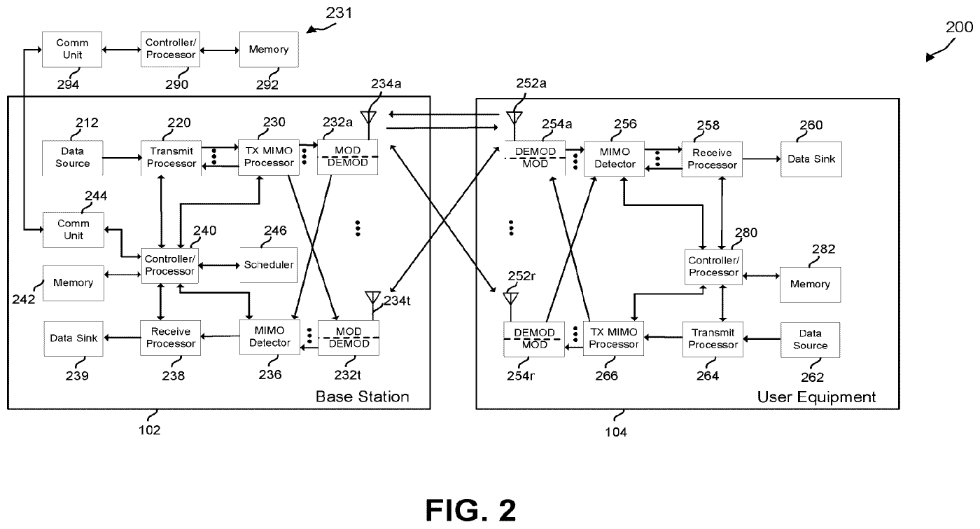

FIG. 2 shows a block diagram of a design of a base station 102 and a UE 104 that enable transmission and processing of signals exchanged between the UE and the base station, in accordance with some aspects of the present disclosure. Design 200 includes components of a base station 102 and a UE 104, which may be one of the base stations 102 and one of the UEs 104 in FIG. 1. Base station 102 may be equipped with T antennas 234a through 234t, and UE 104 may be equipped with R antennas 252a through 252r, where in general T≥1 and R≥1.

At base station 102, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. The modulators 232a through 232t are shown as a combined modulator-demodulator (MOD-DEMOD). In some cases, the modulators and demodulators can be separate components. Each modulator of the modulators 232a to 232t may process a respective output symbol stream, e.g., for an orthogonal frequency-division multiplexing (OFDM) scheme and/or the like, to obtain an output sample stream. Each modulator of the modulators 232a to 232t may further process (e.g., convert to analog, amplify, filter, and upconvert) the output sample stream to obtain a downlink signal. T downlink signals may be transmitted from modulators 232a to 232t via T antennas 234a through 234t, respectively. According to certain aspects described in more detail below, the synchronization signals can be generated with location encoding to convey additional information.

At UE 104, antennas 252a through 252r may receive the downlink signals from base station 102 and/or other base stations and may provide received signals to demodulators (DEMODs) 254a through 254r, respectively. The demodulators 254a through 254r are shown as a combined modulator-demodulator (MOD-DEMOD). In some cases, the modulators and demodulators can be separate components. Each demodulator of the demodulators 254a through 254r may condition (e.g., filter, amplify, downconvert, and digitize) a received signal to obtain input samples. Each demodulator of the demodulators 254a through 254r may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like.

On the uplink, at UE 104, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals (e.g., based at least in part on a beta value or a set of beta values associated with the one or more reference signals). The symbols from transmit processor 264 may be precoded by a TX-MIMO processor 266 if application, further processed by modulators 254a through 254r (e.g., for DFT-s-OFDM, CP-OFDM, and/or the like), and transmitted to base station 102. At base station 102, the uplink signals from UE 104 and other UEs may be received by antennas 234a through 234t, processed by demodulators 232a through 232t, detected by a MIMO detector 236 if applicable, and further processed by a receive processor 238 to obtain decoded data and control information sent by UE 104. Receive processor 238 may provide the decoded data to a data sink 239 and the decoded control information to controller (processor) 240. Base station 102 may include communication unit 244 and communicate to a network controller 231 via communication unit 244. Network controller 231 may include communication unit 294, controller/processor 290, and memory 292.

In some aspects, one or more components of UE 104 may be included in a housing. Controller 240 of base station 102, controller/processor 280 of UE 104, and/or any other component(s) of FIG. 2 may perform one or more techniques associated with implicit UCI beta value determination for NR.

Memories 242 and 282 may store data and program codes for the base station 102 and the UE 104, respectively. A scheduler 246 may schedule UEs for data transmission on the downlink, uplink, and/or sidelink.

In some aspects, deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, e.g., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

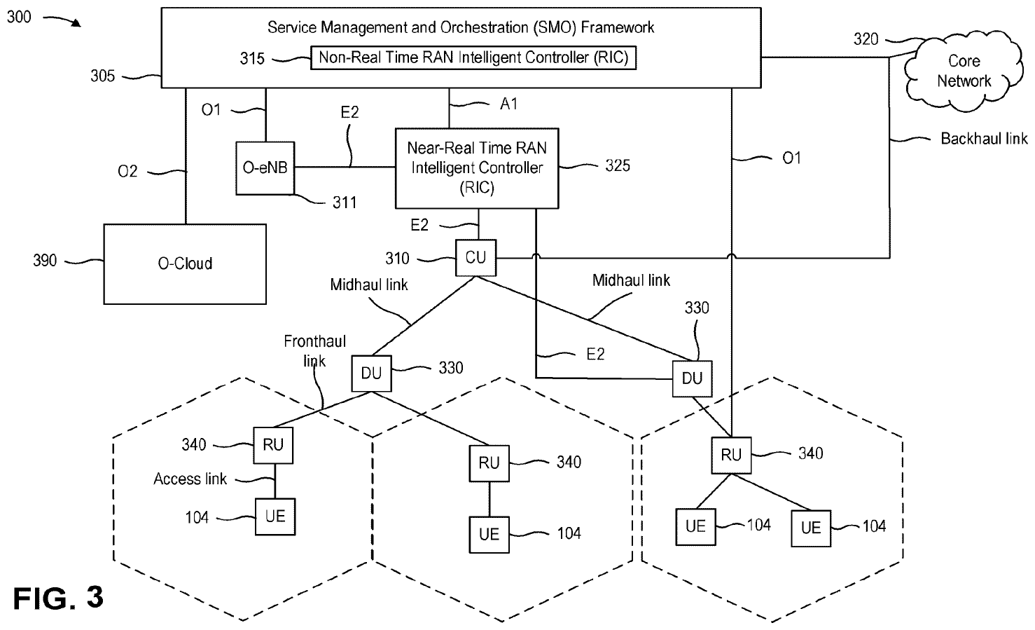

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUS) 340 via respective fronthaul links. The RUs 340 may communicate with respective UEs 104 via one or more radio frequency (RF) access links. In some implementations, the UE 104 may be simultaneously served by multiple RUs 340.

Each of the units, e.g., the CUS 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the El interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 104. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as AI policies).

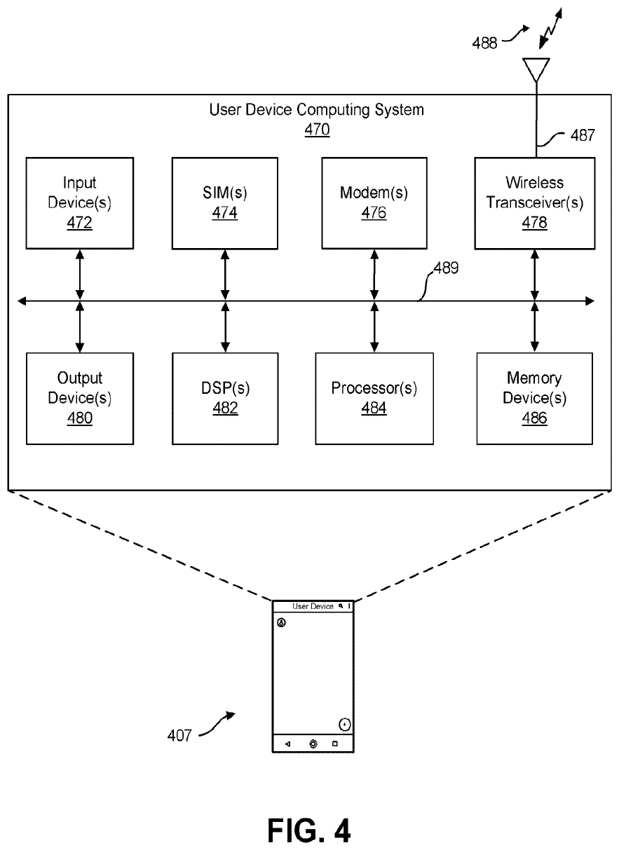

FIG. 4 illustrates an example of a computing system 470 of a wireless device 407. The wireless device 407 may include a client device such as a UE (e.g., UE 104, UE 152, UE 190) or other type of device (e.g., a station (STA) configured to communicate using a Wi-Fi interface) that may be used by an end-user. For example, the wireless device 407 may include a mobile phone, router, tablet computer, laptop computer, tracking device, wearable device (e.g., a smart watch, glasses, an extended reality (XR) device such as a virtual reality (VR), augmented reality (AR) or mixed reality (MR) device, etc.), Internet of Things (IoT) device, a vehicle, an aircraft, and/or another device that is configured to communicate over a wireless communications network. The computing system 470 includes software and hardware components that may be electrically or communicatively coupled via a bus 489 (or may otherwise be in communication, as appropriate). For example, the computing system 470 includes one or more processors 484. The one or more processors 484 may include one or more CPUs, ASICs, FPGAS, APs, GPUs, VPUs, NSPs, microcontrollers, dedicated hardware, any combination thereof, and/or other processing device or system. The bus 489 may be used by the one or more processors 484 to communicate between cores and/or with the one or more memory devices 486.

The computing system 470 may also include one or more memory devices 486, one or more digital signal processors (DSPs) 482, one or more SIMs 474, one or more modems 476, one or more wireless transceivers 478, an antenna 487, one or more input devices 472 (e.g., a camera, a mouse, a keyboard, a touch sensitive screen, a touch pad, a keypad, a microphone, and/or the like), and one or more output devices 480 (e.g., a display, a speaker, a printer, and/or the like).

In some aspects, computing system 470 may include one or more radio frequency (RF) interfaces configured to transmit and/or receive RF signals. In some examples, an RF interface may include components such as modem(s) 476, wireless transceiver(s) 478, and/or antennas 487. The one or more wireless transceivers 478 may transmit and receive wireless signals (e.g., signal 488) via antenna 487 from one or more other devices, such as other wireless devices, network devices (e.g., base stations such as eNBs and/or gNBs, Wi-Fi access points (APs) such as routers, range extenders or the like, etc.), cloud networks, and/or the like. In some examples, the computing system 470 may include multiple antennas or an antenna array that may facilitate simultaneous transmit and receive functionality. Antenna 487 may be an omnidirectional antenna such that radio frequency (RF) signals may be received from and transmitted in all directions. The wireless signal 488 may be transmitted via a wireless network. The wireless network may be any wireless network, such as a cellular or telecommunications network (e.g., 3G, 4G, 5G, etc.), wireless local area network (e.g., a Wi-Fi network), a Bluetooth™ network, and/or other network.

In some examples, the wireless signal 488 may be transmitted directly to other wireless devices using sidelink communications (e.g., using a PC5 interface, using a DSRC interface, etc.). Wireless transceivers 478 may be configured to transmit RF signals for performing sidelink communications via antenna 487 in accordance with one or more transmit power parameters that may be associated with one or more regulation modes. Wireless transceivers 478 may also be configured to receive sidelink communication signals having different signal parameters from other wireless devices.

In some examples, the one or more wireless transceivers 478 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end may generally handle selection and conversion of the wireless signals 488 into a baseband or intermediate frequency and may convert the RF signals to the digital domain.

In some cases, the computing system 470 may include a coding-decoding device (or CODEC) configured to encode and/or decode data transmitted and/or received using the one or more wireless transceivers 478. In some cases, the computing system 470 may include an encryption-decryption device or component configured to encrypt and/or decrypt data (e.g., according to the AES and/or DES standard) transmitted and/or received by the one or more wireless transceivers 478.

The one or more SIMs 474 may each securely store an international mobile subscriber identity (IMSI) number and related key assigned to the user of the wireless device 407. The IMSI and key may be used to identify and authenticate the subscriber when accessing a network provided by a network service provider or operator associated with the one or more SIMs 474. The one or more modems 476 may modulate one or more signals to encode information for transmission using the one or more wireless transceivers 478. The one or more modems 476 may also demodulate signals received by the one or more wireless transceivers 478 in order to decode the transmitted information. In some examples, the one or more modems 476 may include a Wi-Fi modem, a 4G (or LTE) modem, a 5G (or NR) modem, and/or other types of modems. The one or more modems 476 and the one or more wireless transceivers 478 may be used for communicating data for the one or more SIMs 474.

The computing system 470 may also include (and/or be in communication with) one or more non-transitory machine-readable storage media or storage devices (e.g., one or more memory devices 486), which may include, without limitation, local and/or network accessible storage, a disk drive, a drive array, an optical storage device, a solid-state storage device such as a RAM and/or a ROM, which may be programmable, flash-updateable and/or the like. Such storage devices may be configured to implement any appropriate data storage, including without limitation, various file systems, database structures, and/or the like.

In various aspects, functions may be stored as one or more computer-program products (e.g., instructions or code) in memory device(s) 486 and executed by the one or more processor(s) 484 and/or the one or more DSPs 482. The computing system 470 may also include software elements (e.g., located within the one or more memory devices 486), including, for example, an operating system, device drivers, executable libraries, and/or other code, such as one or more application programs, which may comprise computer programs implementing the functions provided by various aspects, and/or may be designed to implement methods and/or configure systems, as described herein.

As noted previously, systems and techniques are described herein for signaling of cell changes and/or beam changes. For instance, the systems and techniques may provide Layer 1 (L1) and/or Layer 2 (L2) signaling of cell and/or beam changes. Alternatively or in addition, in some aspects, the systems and techniques can provide Timing Advance (TA) and/or beam management (BM) for one or more deactivated serving cells.

In some networks, a unified TCI may be used to indicate a common TCI state for multiple channels, multiple RSs, or a channel and an RS. For example, a network may support different types of unified TCIs, such as Type 1 (where a joint TCI state indicates a common beam for at least one downlink channel and/or downlink RS in addition to at least one uplink channel and/or uplink RS), Type 2 (where a downlink TCI state indicates a common beam for more than one downlink channel and/or downlink RS), and/or Type 3 (where a common TCI state indicates a common beam for more than one uplink channel and/or uplink RS).

For at least 3GPP Release 18 (R18) L1/L2 based mobility, L1/L2 signaling for serving cell changes is to be specified. For example, to specify mechanisms and procedures of L1/L2 based inter-cell mobility for mobility latency reduction, the following may be addressed: configuration and maintenance for multiple candidate cells to allow fast application of configurations for candidate cells [RAN2, RAN3]; Dynamic switch mechanism among candidate serving cells (including SpCell and SCell) for the potential applicable scenarios based on L1/L2 signaling [RAN2, RAN1]; L1 enhancements for inter-cell beam management, including L1 measurement and reporting, and beam indication [RAN1, RAN2] (Note 1: Early RAN2 involvement is necessary, including the possibility of further clarifying the interaction between this bullet with the previous bullet); Timing Advance management [RAN1, RAN2]; and CU-DU interface signaling to support L1/L2 mobility, if needed [RAN3].

The systems and techniques described herein can address at least the dynamic switching mechanism among candidate serving cells (including SpCell and SCell) for the potential applicable scenarios based on L1/L2 signaling and the L1 enhancements for beam indication.

The term SpCell refers to a Special Cell. In some cases, such as for Dual Connectivity operation, the term Special Cell (SpCell) may refer to the Primary Cell (PCell) of the Master Cell Group (MCG) or the PSCell of the Secondary Cell Group (SCG) depending on if the MAC entity is associated to the MCG or the SCG, respectively. Otherwise the term Special Cell may refer to the PCell. A Special Cell may support Physical Uplink Control Channel (PUCCH) transmission and contention-based Random Access, and in some cases is always activated.

In some cases, with respect to preconfigured candidate cells for an L1/L2 based cell change is as follows, a set of candidate cells are configured as serving cell(s) within a cell group at least for SpCell reselection. A first option (denoted as Option 1) and a second option (denoted as Option 2) are as follows (with differences between Options 1 and 2 shown with text between brackets—e.g., “<differences>”):
Option 1: A subset of configured serving cells are dedicated as candidate cells
   Only one candidate cell is selected as SpCell at a given time, and <remaining candidate cells not selected as SpCell are not used for data and control communications>
   Each serving cell configured in the cell group but not in the candidate cell subset may be activated or deactivated as SCell for data and/or control communications
Option 2: Any or subset of serving cells configured in the cell group can be a candidate cell
Dedicated cell switching signaling selects a candidate cell as the new SpCell
   The selected candidate cell is previously activated to be ready for data and/or control communications, e.g. as an activated SCell, or is either activated or deactivated before the selection, e.g. as a deactivated SCell
   To save overhead, some serving cell config for SpCell functions may be valid only when the candidate cell is selected as SpCell, e.g. SSB, RACH (or PRACH), paging, SI config
<Each serving cell including candidate cell configured in the cell group if not selected as SpCell can be activated or deactivated as SCell for data and control communications>

For both Options 1 and 2, the activated SCells not selected as the new SpCell after the selection may have the following behavior: they are implicitly deactivated after SpCell change, and may be reactivated later after potential RRC reconfiguration; or they remain activated after SpCell change.

In some examples, individual cell selection may be implemented using separate cell signaling for PCell change and/or SCell change in case of carrier aggregation. In some aspects, beam indication based PCell selection can be performed. In some cases, SCell selection can be based on legacy protocols and/or new L1/L2 signaling, as discussed further herein. In some instances, a single PCell (e.g., without carrier aggregation and/or dual connectivity) may be selected among a pre-configured candidate PCell set. In some examples, a PCell change may include sweeping the role between a PCell and a SCell among a pre-configured candidate PCell set.

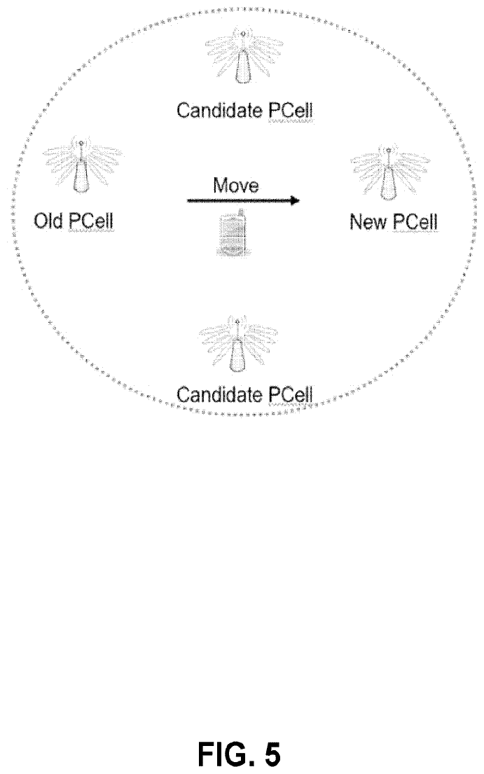

FIG. 5 illustrates an example of a single PCell change without carrier aggregation. In some aspects, the UE may switch from the Old PCell to the New PCell from among a pre-configured candidate PCell set.

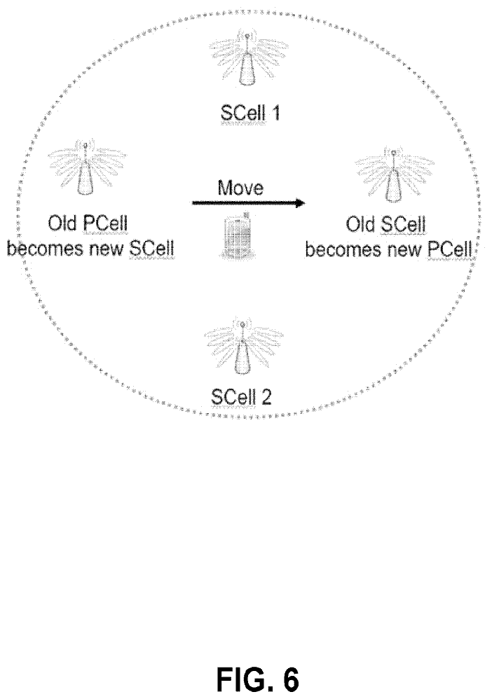

FIG. 6 illustrates an example of an individual PCell and SCell change in carrier aggregation. In some examples, the Old SCell may be changed into the new PCell. In some cases, the old PCell may be changed into the new SCell. In some examples, the new SCell may be implicitly deactivated after SpCell change, and may be reactivated later after potential RRC reconfiguration; or the new SCell may remain activated after SpCell change.

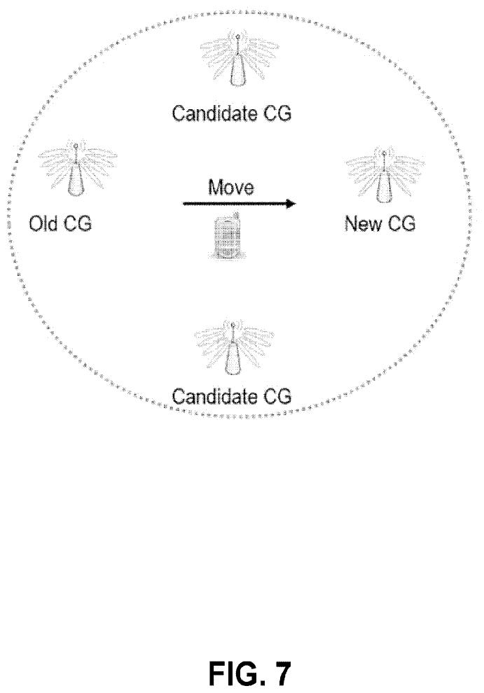

FIG. 7 illustrates an example of cell group based selection in which an SpCell and an SCell may be switched together in the case of carrier aggregation. In some aspects, cell group switch signaling may be based on an extension of signaling for example in FIG. 6. In some examples, a UE may switch from an old cell group to a new cell group, as illustrated in FIG. 7.

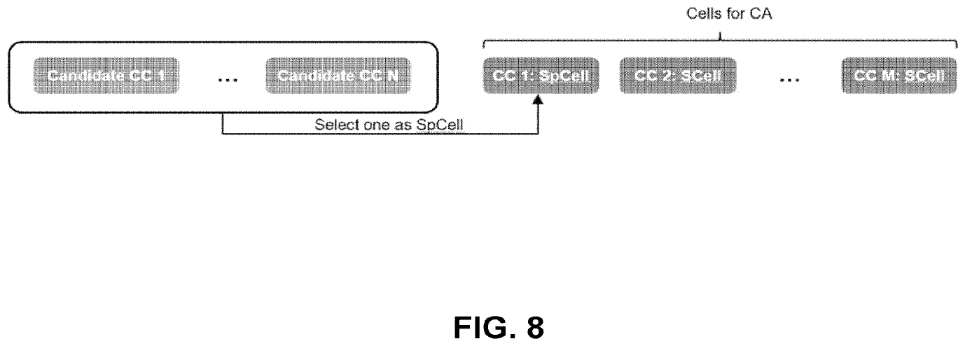

FIG. 8 illustrates an example of preconfigured candidate cells for L1/L2 based SpCell change. In some examples, FIG. 8 may correspond to Option 1 set forth above in which a subset of serving cells are dedicated as candidate cells for SpCell selection (e.g., candidate Pcells in an Information Element (IE) such as CellGroupConfig, including candidate component carrier (CC1) to candidate CC N). In some cases, only one candidate cell may be selected as SpCell at a given time and one or more remaining candidate cells that are not selected may not be used for data and control communications.

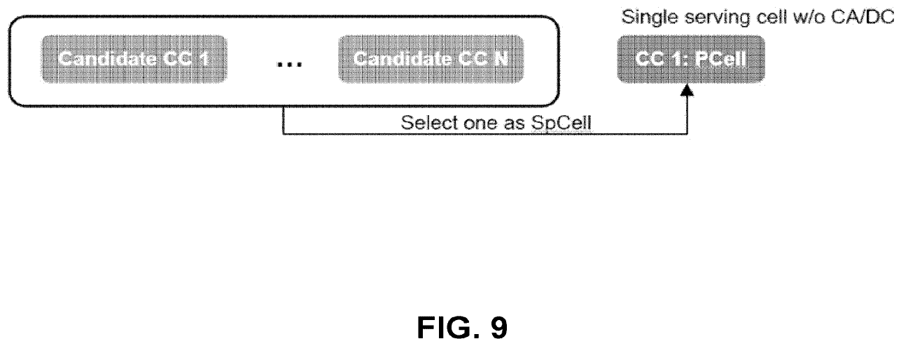

FIG. 9 illustrates another example of preconfigured candidate cells for L1/L2 based SpCell selection. As illustrated in FIG. 9, in a case of a single serving cell without carrier aggregation or dual connectivity, a single PCell may be configured.

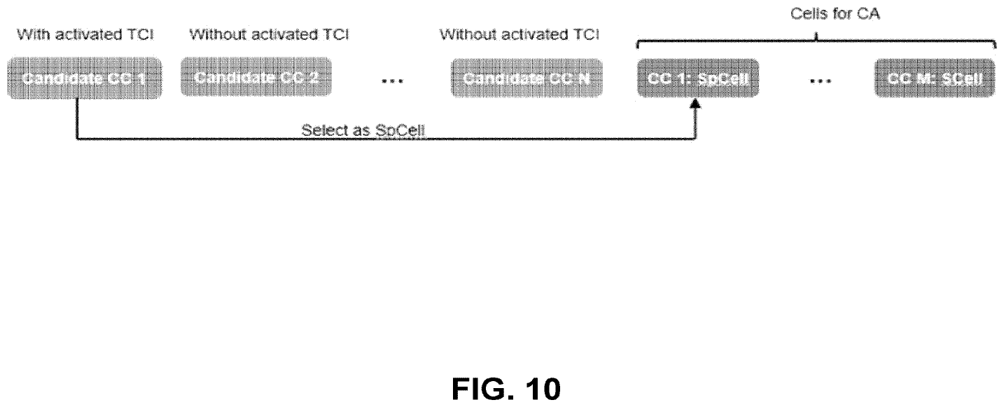

FIG. 10 illustrates an example of SpCell selection in which non-selected cells are not used for data and control communications. In some aspects, among the candidate SpCells, only the selected SpCell may have an activated transmission configuration indicator (TCI) state.

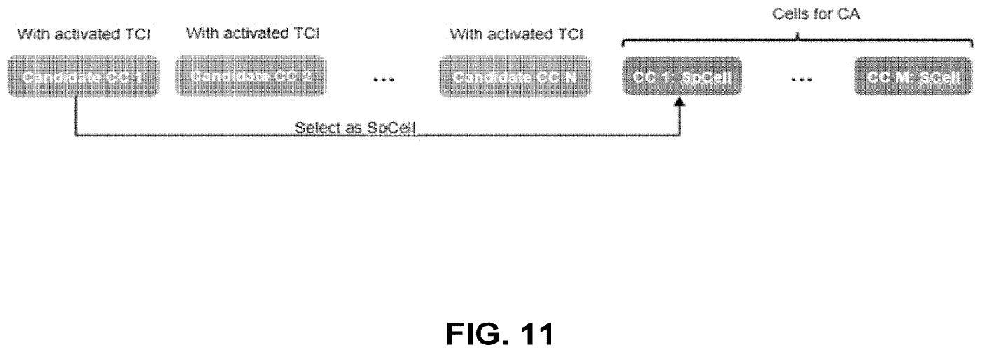

FIG. 11 illustrates another example of SpCell selection in which non-selected cells are not used for data and control communications. In some cases, among the candidate SpCells, both selected and non-selected SpCells may have activated TCI states. In some examples, the non-selected SpCells may not be used for data/control.

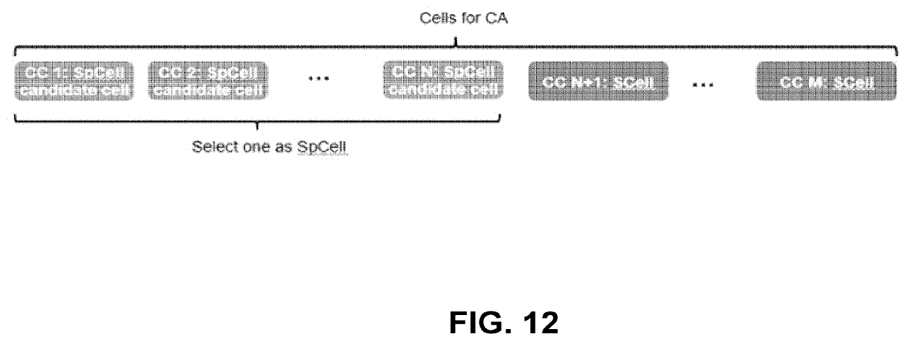

FIG. 12 illustrates an example of SpCell selection in which non-selected cells may be used for data and control communications. For example, among configured component carriers (CC) for carrier aggregation, a set of component carriers may also be candidate cells for SpCell selection (e.g., CC1 to N). In some aspects, a difference between the example illustrated in FIG. 12 and the examples illustrated in FIG. 10 or FIG. 11 is that a candidate cell not selected as SpCell may be used for data and control communications (e.g., as an activated SCell). In some instances, the example illustrated in FIG. 12 may include carrier aggregation. In some aspects relating to a single serving cell, it may be virtually achieved by only activating the SpCell while keeping all SCells deactivated.

In some aspects, the L1/L2 signaling may be applied to indicate the cell change (e.g. SpCell change), which may include two options. A first option (referred to as Option A) may include a beam-indication based cell switch command, where a beam indication signaling may not only provide a beam indication, but also provide the cell change to the new cell. The beam indication signaling may provide the cell ID for cell change and applying the indicated beams. For instance, according to Option A, the switching to a new cell may be implicitly indicated by a MAC Control Element (MAC-CE) or Downlink Control Information (DCI) (e.g., received by a UE via PDCCH) indicating to the UE to use at least one Transmission Configuration Indicator (TCI) state per direction (e.g., at least one TCI state for downlink (DL) and/or at least one TCI state for uplink (UL)) configured for the new cell. In some cases, this technique may be suitable for Option 1 noted above (a subset of configured serving cells are dedicated as candidate cells), where the new cell is not used for data/control communications before the switching (e.g. the new cell was not activated as a SCell before the cell change). In some examples, the MAC-CE or DCI can be sent from the old cell before the cell change. In some cases, using at least one TCI state per direction (e.g., DL and/or UL) configured for the new cell may be indicated using Layer-2 MAC-CE based beam indication where MAC-CE may activate a single TCI codepoint mapped to that at least one TCI state per direction to the new cell. In some examples, using at least one TCI state per direction (e.g., DL/UL) configured for the new cell can be indicated using Layer-1 DCI based beam indication, where DCI (e.g., of DCI format 1_1 or 1_2) may select a TCI codepoint mapped to that at least one TCI state per direction. In some examples, the at least one TCI state per direction includes a joint TCI state, a pair of DL TCI and UL TCI state, a single DL TCI state, a single UL TCI state, or other configuration. In response to reception of the beam indication signaling, the UE may perform the cell switch or the cell change for the indicated cells, and also apply the beam indication for the indicated cells.

A second option (referred to as Option B) for the L1/L2 signaling to indicate the cell change may include a dedicated cell switch command. For instance, according to Option B, the switching to a new cell may be signaled by a dedicated MAC-CE or DCI that at least includes an identifier (ID) of the new cell (e.g., a physical cell identity or identifier (PCI) or serving cell ID). In some cases, the PCI can be denoted as PhysCellId. In some cases, this technique may be suitable for Option 1 as noted above (a subset of configured serving cells are dedicated as candidate cells), where the new cell is not used for data and control communication before the switching (e.g. the new cell was not activated as a SCell). In some aspects, this technique may be suitable for Option 2 as noted above (any or subset of serving cells configured in the cell group may be active and may be a candidate cell), where the new cell may be used for data and control communication before (e.g. the new cell was an activated SCell). In some examples, the dedicated cell switch command (dedicated MAC-CE or DCI) may include other operation parameters for the new cell, such as including beam indication, timing Advance (TA) command, power control (PC) parameter indications, active DL and UL Bandwidth Parts (BWPs) indications. In one example, a single TCI (e.g., only a single TCI) per direction (e.g., one TCI per DL and one TCI per UL) may be indicated for the new cell (e.g., only single TRP (sTRP) operation is enabled for the new cell at the beginning after the cell change). In another example, multiple TCIs per direction (per DL/UL) may be indicated for the new cell (e.g., multiple TRP (mTRP) operation is enabled for the new cell at the beginning after the cell change). In some examples, the same dedicated cell switch command (dedicated MAC-CE or DCI) may indicate a new SpCell and/or multiple SCells with each cell identified by its serving cell ID and indicated for its role (e.g., the role as SpCell or as SCell), where each Scell may be activated or deactivated. In one example, a common TCI state ID may be signaled for multiple new cells, including new SpCell and new SCells. In another example, each new cell including new SpCell and new SCells can be signaled with a TCI state ID. In some cases, when DCI is used in Option B as dedicated cell switch command for cell change, the DCI may or may not schedule DL/UL assignment (e.g., PDSCH and/or PUSCH). In some aspect, the UE may provide a dedicated feedback (e.g., ACK/NACK) as the confirmation for receiving the signaling of the DCI without DL/UL assignment.

Additionally or alternatively, in some other aspects, the application time for each new cell may be specified. In some examples, the application time may refer to the time from which a UE receives an indication to switch or change cells and the time the UE implements cell switching or change. In one example, such as if the new cell is signaled via MAC-CE as the cell change signaling, the application time can be a number of X milliseconds (ms) from the end of UL slot carrying the feedback (e.g., ACK) for the MAC-CE. In another example, such as if the new cell is signaled via DCI as the cell change signaling, at least two options may be provided. In a first option (if the new cell is signaled via DCI), the application time may be the start of first slot after X ms or symbols from the end of feedback (e.g., ACK) for the DCI. According to the first option, in the case of X symbols, the subcarrier spacing (SCS) may be the SCS of the active DL or UL BWP of the new cell, the smallest (or largest SCS) of the active DL and UL BWPs of the new cell, or other SCS. In a second option (if the new cell is signaled via DCI), the application time may be the start of first slot after X ms or symbols from the DCI. According to the second option, in the case of X symbols, the SCS may be the SCS of the active DL BWP of the signaling cell, the SCS of the active DL or UL BWP of the new cell, the smallest (or largest SCS) of the active DL and UL BWPs of the new cell and the active DL and UL BWPs of the signaling cell, or other SCS. In some cases, the signaling cell may refer to the cell that transmits the DCI to the UE. In one or more of the above examples, the X (e.g., X ms, X symbols, etc.) may be different depending on whether the new cell has been previously activated or not. In some examples, in the case of X symbols, the X may be configured per SCS and subject to UE capability. In some examples, in case of multiple new cells, a common application time may be defined (e.g., as the longest application time among all the multiple new cells).

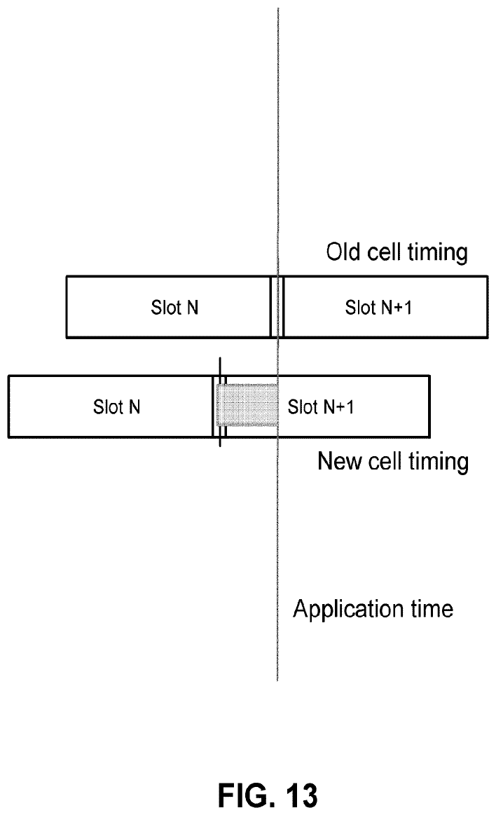

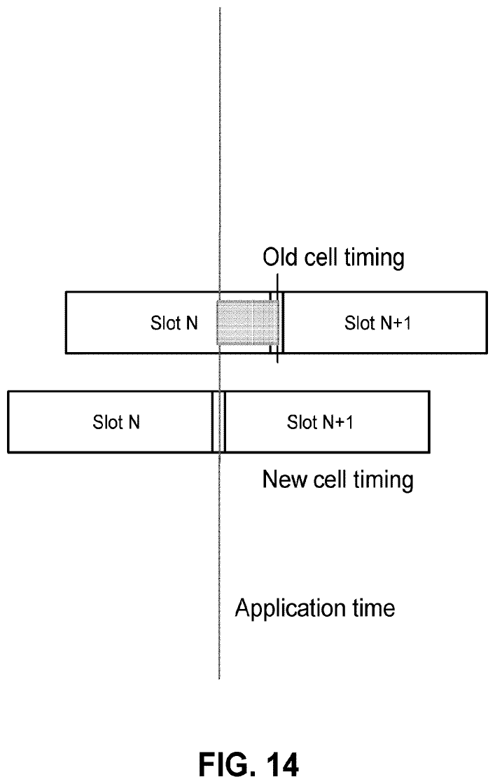

Additionally or alternatively, in some other aspects, in case that the reception (Rx) timing is greater than the length of cyclic prefix (CP) or different TA value is applied for old and new cells, the slot boundary of the application time may be determined using various options. According to a first option, the slot boundary of the application time may be determined by the slot boundary of the new cell, and any transmission and/or reception (Tx/Rx) on the old cell will be taken into account. FIG. 13 is a diagram illustrating an example of the slot boundary of the application time being determined by the slot boundary of the new cell. In one example, any Tx/Rx on the old cell may be dropped if exceeding the application time based on new cell's slot boundary. In another example, any Tx/Rx on the old cell may be prioritized as long as not exceeding the application time based on old cell's slot boundary. According to a second option, the slot boundary of the application time may be determined by the slot boundary of the old cell, and any Tx/Rx on the new cell will be taken into account. FIG. 14 is a diagram illustrating an example of the slot boundary of the application time being determined by the slot boundary of the old cell. In one example, any Tx/Rx on the new cell may be dropped if prior to the application time based on old cell's slot boundary. In one example, any Tx/Rx on the new cell may be prioritized as long as not prior to the application time based on new cell's slot boundary.

Additionally or alternatively, in some other aspects, such as to reduce tracking reference signal (TRS) and beam refinement latency after a cell switch or a cell change, the signaling (e.g., MAC-CE or DCI) indicating a new cell (e.g., as new SpCell or SCell) may also trigger or activate one or more aperiodical (AP) and/or semi-persistent (SP) reference signal that may include Channel State Information Reference Signal (CSI-RS) for Tracking Reference Signal (TRS), aperiodical and/or semi-persistent CSI-RS in a CSI-RS resource set with repetition parameter set as “ON” (e.g., for beam refinement), or aperiodical (AP) or semi-persistent (SP) CSI-RS for beam report or for CSI report. In some cases, the signaling (e.g., MAC-CE or DCI) may indicate the ID of AP or SP CSI-RS resource(s) or resource set to be triggered or activated. In some cases, the scheduling offset from the end of the MAC-CE or DCI (or from the end of the feedback associated with the MAC-CE or DCI, such as an ACK) to the start of AP/SP CSI-RS may be RRC configured. In some examples, if AP or SP CSI-RS has no explicitly signaled TCI state, the TCI state may be implicitly determined as the indicated joint TCI or DL TCI for the new cell in the signaling of new cell switch command.

Additionally or alternatively, in some other aspects, such as to save beam training latency after a serving cell switch or a serving cell change, the network may indicate two CSI-RS resources or two CSI-RS resource sets which are configured for serving and neighbor cells are resource-wise linked, such that the linked two CSI-RS resources indicate the UE to apply the same reception beam. In one illustrative example, a CSI-RS #1 configured for the new serving cell is linked to the CSI-RS #3 configured for the old serving cell, and the network indicates a cell change to the new serving cell with the new TCI with CSI-RS #1 as QCL-TypeD. Based on the linkage, the new TCI with CSI-RS #1 as QCL-TypeD corresponds to the same UE Rx beam indicated by the old TCI with CSI-RS #3 as QCL-TypeD. In some cases, instead of a CSI-RS resource or resource set, the linked RRC parameters may be two TCI states or TCI state sets configured for serving and neighbor cells.

Additionally or alternatively, as noted above, the systems and techniques can provide Timing Advance (TA) and/or beam management (BM) for one or more serving cells not used for data and control communications (e.g., deactivated cells).

In some aspects, TA may be measured and signaled to a UE for a configured serving cell that is not used for data and control communications (e.g., a deactivated SCell), which can be a candidate cell for selection as a new SpCell in L1/L2 based mobility (e.g., using L1/L2 based signaling described above). To speed up the cell switch, random access (RACH) transmissions may be transmitted and a TA command may be updated for a configured serving cell that is not used for data and control communications (e.g., a deactivated SCell).

Additionally or alternatively, in some other aspects, radio link monitoring (RLM) and/or beam failure detection (BFD) operations may be performed for a configured serving cell not used for data and control communications (e.g. a deactivated SCell), which can be a candidate cell for a new SpCell in L1/L2 based mobility.

Additionally or alternatively, in some other aspects, in L1/L2 based inter-cell mobility, a UE may be pre-configured or pre-indicated with the beam(s) for different channels/RSs of a configured serving cell not used for data and control communications (e.g., a deactivated SCell), which can be a candidate cell for a new SpCell in L1/L2 based mobility. In some cases, the pre-indicated/configured beam(s) may be applied implicitly after the candidate cell is selected for use (e.g., as the new SpCell), without separate beam indication signaling.

Additionally or alternatively, in some other aspects, such as to reduce TRS tracking latency after a cell switch or a cell change, a MAC-CE may activate a TCI state configured for a candidate cell which is not selected for use yet. In some cases, a MAC-CE may be sent from a currently used cell (or old cell) with an applied cell ID as the intended candidate cell (or new cell). The MAC-CE may be sent before the cell switching or the cell change. In some examples, the activated TCI(s) per candidate cell not used for data and control communications may be counted in the UE capability based on a maximum number of active TCI per component carrier (CC) or cell and across CCs or cells in the same band, in some cases by treating a candidate cell not used for data and control communications as one used serving cell for the UE capability counting purpose.

Additionally or alternatively, in some other aspects, to reduce beam refinement latency after a cell switch, a DCI can trigger an aperiodical (AP) CSI-RS resource set with repetition parameter set as “ON” configured for a candidate cell not selected for use yet. In some cases, the DCI can be sent from current serving cell (or old cell) with a carrier indicator field (CIF) indicating the intended unused candidate cell (or new cell). In some examples, each CSI-RS resource in the set has TCI state configured for the unused candidate cell.

Additionally or alternatively, in some other aspects, various assumptions can be made as follows for preconfigured candidate cells. According to a first assumption (referred to as “Assumption 1”), a subset of configured serving cells is dedicated as candidate cells for SpCell selection. In accordance with Assumption 1, each serving cell configured in the cell group but not in the candidate cell subset can be activated or deactivated as an SCell for data and/or control transmission.

According to a second assumption (referred to as “Assumption 2), any or subset of serving cells configured in the cell group for carrier aggregation (CA) operation can be a candidate cell for SpCell selection. In some cases, in accordance with Assumption 2, dedicated cell switching signaling selects a candidate cell as the new SpCell. In some example, before the selection, the selected candidate cell can be either activated or deactivated (e.g., as a deactivated SCell). In some examples, before the selection, the selected candidate cell must be previously activated and are ready for data/control transmission (e.g., as an regular activated SCell). In some examples, the selected candidate cell may be an SCell previously in a dormant bandwidth part (BWP), which can be reported for P/SP CSI. In some cases, in accordance with Assumption 2, to save overhead, some serving cell configuration(s) for SpCell functions can be valid only when the candidate cell is selected as SpCell (e.g., SSB, RACH, paging, SI config, etc.).

For both Assumption 1 and Assumption 2, the activated SCells not as the new SpCell after the selection may have the following behavior:
Assumption 1: they are implicitly deactivated after SpCell change, and may be reactivated later after potential RRC reconfiguration.
Assumption 2: they remain activated after SpCell change.

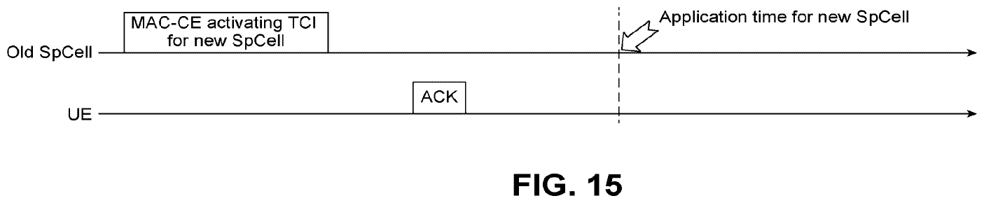

In some aspects in view of one or more of the above Assumptions 1 and 2, the L1/L2 signaling for the used cell change, e.g. SpCell change, can be based on a beam indication and/or a beam activation command. When it is assumed that a non-selected candidate cell is not used for data and/or control transmission and only selected candidate cell has an activated Transmission Configuration Indicator (TCI), the switching to a new SpCell may be indicated by a MAC-CE activating at least one TCI state configured for the new cell. The at least one TCI state per direction may include a joint DL/UL TCI state, a pair of separate DL and UL TCI states (e.g., a single separate DL TCI state, or a single separate UL TCI state). These features are shown in FIG. 15.

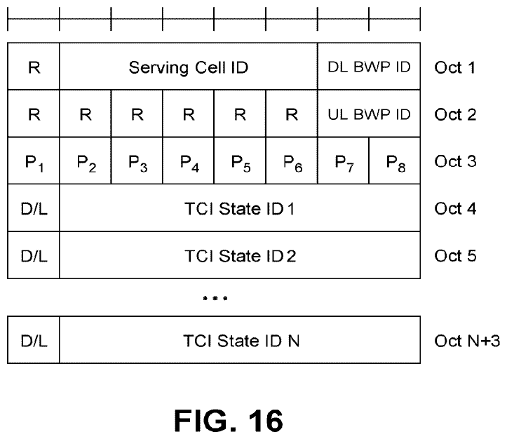

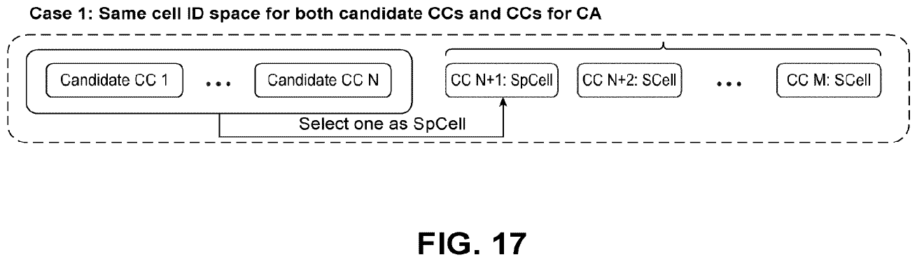

Additionally or alternatively, in some other aspects, the signaling of cell change may be based an existing unified TCI activation MAC-CE as shown in FIG. 16. In one example case, if the cell ID of candidate SpCell shares the same serving cell ID space as for SpCell plus SCell in CA, e.g. 0-31. The existing unified TCI activation MAC-CE may be reused to indicate the SpCell change. In the MAC-CE, if the serving cell ID is a candidate SpCell, the fields of serving cell ID, DL/UL BWP IDs, TCI codepoint are used as for the new SpCell ID, the corresponding active DL/UL BWP IDs, and the TCI codepoint to be used for the new SpCell ID after the SpCell change, respectively as shown in FIG. 17. The field Pi indicates whether the ith TCI codepoint is a single TCI or a pair of TCIs (i=0, . . . 8).

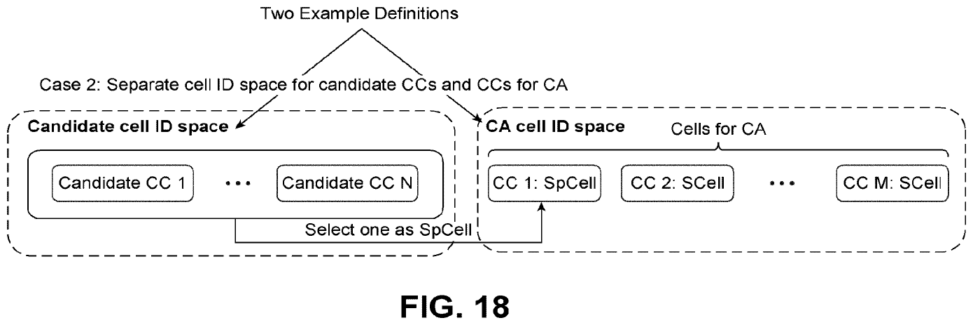

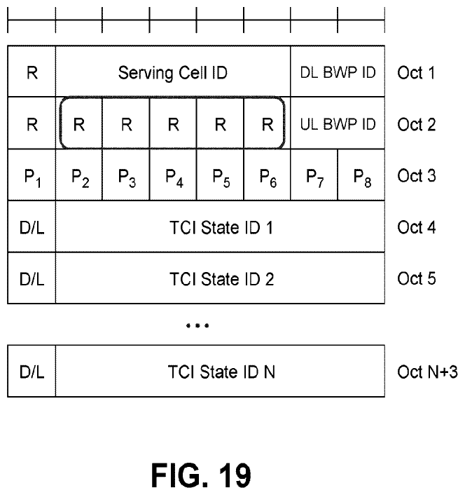

Additionally or alternatively, in some other aspects, if cell ID of candidate SpCell has separate serving cell ID space from SpCell plus SCell in CA (e.g. a candidate SpCell ID is from 0-9, while an serving cell ID for CA is from 0-31), the new SpCell may have the old SpCell ID, e.g., ID 0 for PCell, as shown in FIG. 18. Further, in this scenario, if a candidate cell ID is signaled for TCI activation, this candidate cell is the new SpCell, and there are several options. One option includes signaling a candidate cell ID of a candidate SpCell may reuse the field of serving cell ID. In this case, a separate indicator (e.g. by using a reserved bit such as the first “R” bit in October 1 shown in FIG. 19) may be used to inform whether the serving cell ID field carries a candidate cell ID or a regular serving cell ID in CA. In another option, the system may signal a candidate cell ID of a candidate SpCell using a dedicated new field, e.g. using reserved bits (such as the bolded “R” bits in October 2 of FIG. 19), which are all 0s if not used. The existence of the candidate cell ID can be implied by non-zero value of the dedicated field, or explicitly indicated by a separate indicator, e.g. by using a reserved bit.

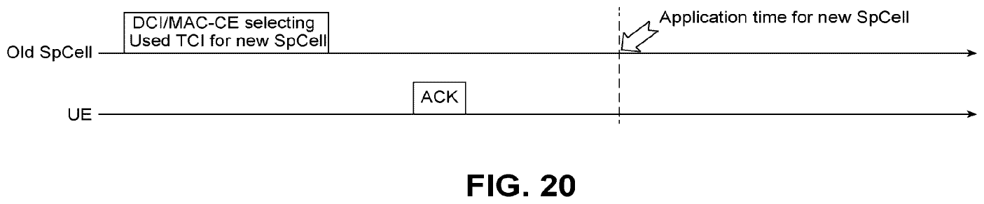

Additionally or alternatively, in some other aspects in accordance with one or more of Assumption 1 and 2 above, in the case of an assumption where a non-selected candidate cell is not used for data and/or control transmission and both selected and non-selected candidate cells can have activated TCIs, the switching to a new cell may be indicated by a MAC-CE or a DCI indicating the UE to use at least one TCI state configured for the new cell. Further, the at least one TCI state used for the new cell can be indicated by different options. A first option may be the MAC-CE activating a single TCI codepoint mapped to that at least one TCI state. In some cases, this option assumes one (e.g., only one) candidate cell has single activated TCI codepoint, and other candidate cells have either multiple or none. A second option may be the DCI selecting a TCI codepoint mapped to that at least one TCI state, among multiple activated TCI codepoints, as shown in FIG. 20.

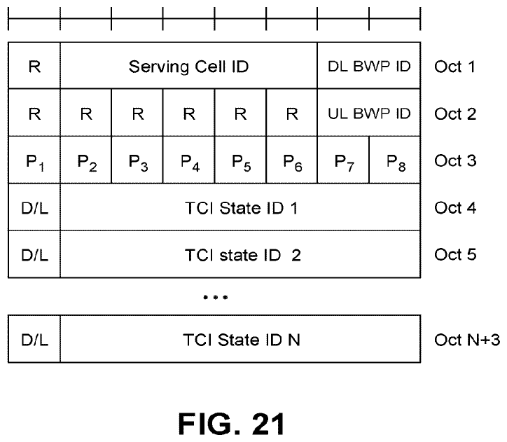

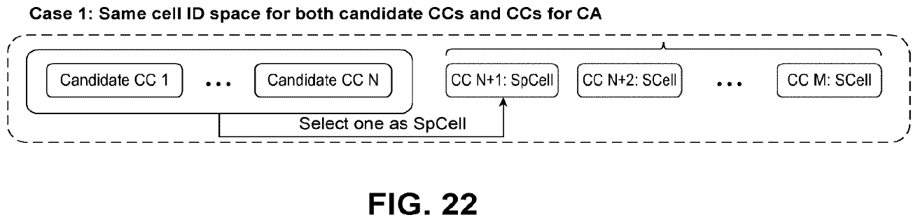

For MAC-CE based used TCI indication, e.g. the first option above (relating to MAC-CE activating a single TCI codepoint mapped to that at least one TCI state), the clarification/change depends on Scenarios 1 or 2 defined before. For the case above relative to FIG. 17, same clarification as in that case for some of the assumptions above except for the part within brackets <*>: If the serving cell ID is a candidate SpCell <with a single activated TCI codepoint>, the fields of serving cell ID, DL/UL BWP IDs, TCI codepoint are used as for the new SpCell ID, the corresponding active DL/UL BWP IDs, and the TCI codepoint to be used for the new SpCell ID after the SpCell change, respectively. This is shown in FIG. 21 and FIG. 22.

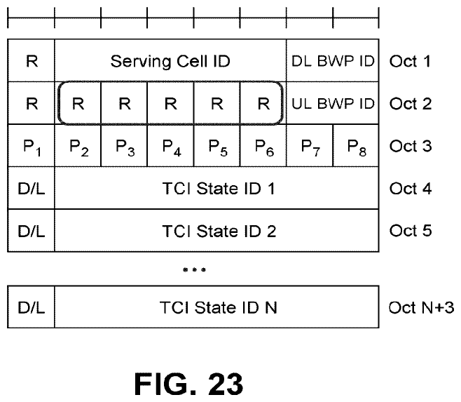

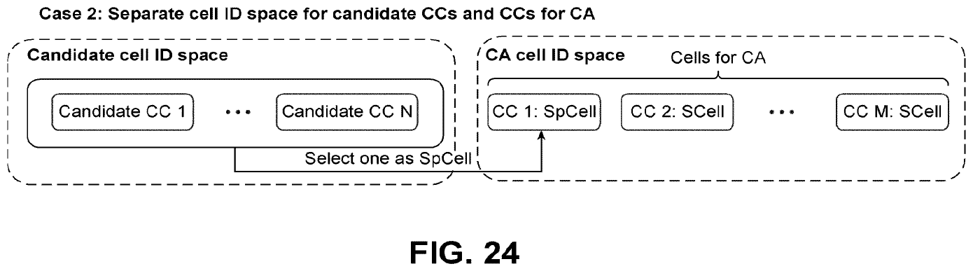

For another case above relative to FIG. 18, in addition to signaling the candidate cell ID (e.g., either in serving cell ID field or a dedicated field as in the second scenario associated with the assumption of FIG. 20), a new clarification is that the candidate cell ID is the new SpCell if it has a single activated TCI codepoint with reference to FIG. 23 and FIG. 24.

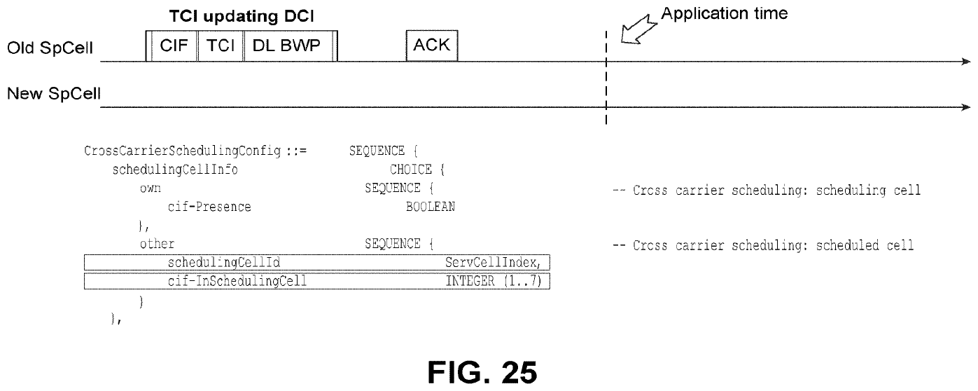

Additionally or alternatively, in some other aspects, for a DCI based TCI indication, e.g. where the clarification/change to indicate the new SpCell is described below. For the case of using a same cell ID space, the TCI updating DCI in format 1_1 or 1_2 without or without DL assignment same as in Release 17 (R17) may be reused. For example, the existing carrier indicator field in the DCI may be reused to indicate the new SpCell if indicating a candidate SpCell cell. Further, each candidate cell should have corresponding carrier indicator field (CIF) codepoint configured per scheduling cell as highlighted in FIG. 25.

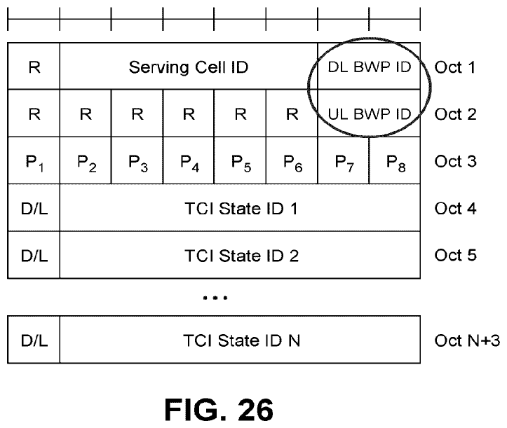

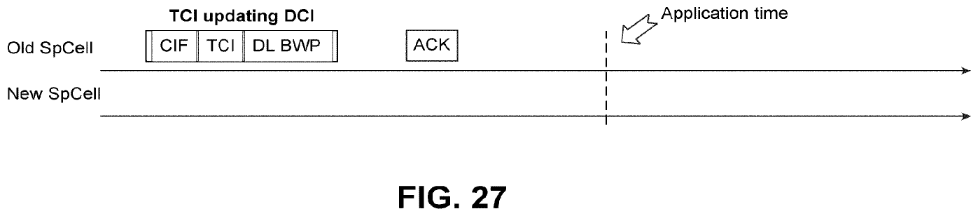

Additionally or alternatively, in some other aspects, for the case of using same cell ID space, the TCI updating DCI in format 1_1 or 1_2 without or without DL assignment same as in R17 may be reused with the following clarifications. The TCI codepoint field in DCI indicates the TCI(s) to be used for the new SpCell. The DL BWP field in DCI indicates the DL and UL BWPs associated with the indicated TCI codepoint upon its activation for this cell, and the associated DL and UL BWPs are used as active BWPs of the new SpCell, as shown in FIGS. 26 and 27. The case of using same cell ID space may not allow DCI to schedule DL/UL assignment, since the CIF field is used to indicate the new SpCell while the TCI for the new SpCell is most likely to be applied after the ACK for the DCI.

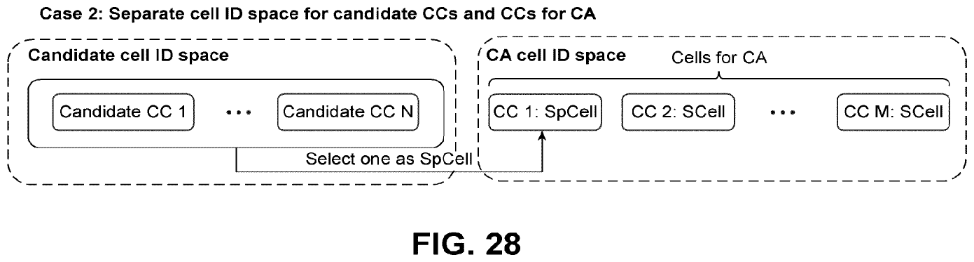

Additionally or alternatively, in some other aspects, for the case of using a separate cell ID space, there are several options to signal the candidate cell ID of the new SpCell in the TCI updating DCI. In one option, signaling of the candidate cell ID can reuse the CIF field in the DCI. A separate indicator, e.g. by using a reserved bit in the DCI, may be used to inform whether the CIF carries a candidate cell ID or a CA cell ID. There may be reserved bits in R17 TCI updating DCI without DL assignment, and one bit may be reserved for such purpose. The TCI codepoint field indicates the TCI(s) to be used for the new SpCell. In another aspect, the DL BWP field indicates the DL and UL BWPs associated with the indicated TCI codepoint upon its activation for this SpCell, and the associated DL and UL BWPs are used as active BWPs of the new SpCell. FIG. 28 shows this feature.

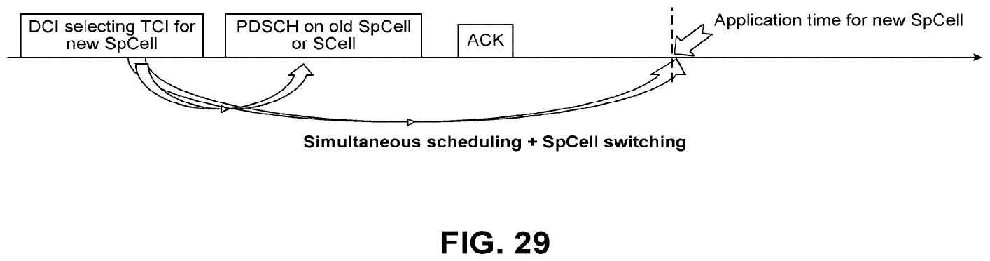

Additionally or alternatively, in some other aspects with reference to FIG. 29, another option includes signaling of the candidate cell ID uses a new field in DCI. In this option, no candidate cell ID carried in the new field may be signaled by a special value of the new field, e.g. all 0s, or by a separate indicator in the DCI. Additional new fields can also be introduced to indicate TCI, active DL/UL BWPs, timing advance (TA) command, and/or other operation parameters for the new SpCell. The new fields can use reserved bits in the R17 TCI updating DCI without DL assignment. The new fields need additional DCI payload in the R17 TCI updating DCI with DL assignment. However, it allows DCI to schedule DL/UL assignment to another cell, e.g. old SpCell or a SCell, while indicating the new SpCell simultaneously.

For above under one of the cases according to one or more of Assumptions 1 and 2 noted above, where cell ID of candidate SpCell shares the same serving cell ID space as for SpCell plus SCell in CA, e.g. 0-31, an issue is whether the serving cell ID for the new PCell should be maintained as 0 as in legacy. One option is that serving cell ID of new PCell does not need to be maintained as 0. For example, if a candidate PCell is selected as the new PCell, the serving cell ID of the selected candidate PCell may be used as that of the new PCell. Another options is a serving cell ID of the new PCell is still maintained as 0. Yet another option is if a candidate PCell is selected as the new PCell, in this case, the serving cell ID of the candidate PCell selected for the new Pcell and the ID of the old PCell are swapped without separate signaling, such that the serving cell ID of the PCell is always 0. As another option, every serving cell including candidate PCell has an original non-zero serving cell ID, e.g. 1-31. When a candidate PCell is selected as the new PCell, its serving cell ID is overwritten by 0. When the old PCell is not selected as the new PCell, it has its original non-zero serving cell ID.

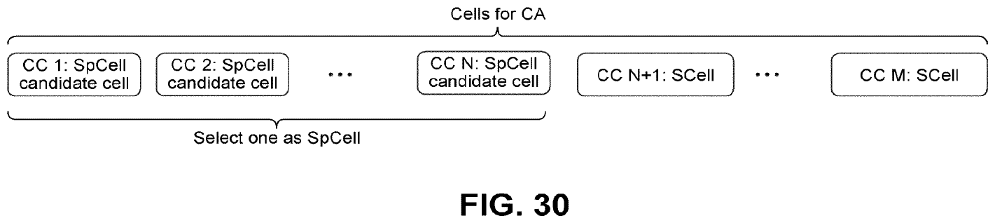

Additionally or alternatively, in some other aspects with reference to FIG. 30, in case of the assumption where the candidate SpCell if not selected as SpCell can also be used, e.g. as active SCell, there are several cases. In a first case, if the new selected SpCell previously is an activated SCell, a new indicator can be added to a TCI activation MAC-CE or a TCI updating DCI to indicate whether the serving cell signaled in the serving cell ID field of MAC-CE or in the CIF field of DCI is selected as the new SpCell or remains as SCell. For TCI updating DCI, if the DCI has no DL assignment, the new bit may reuse one or more bits reserved in the R17 TCI updating DCI, such as frequency domain resource allocation (FDRA), virtual resource block (VRB)-to-physical resource block (PRB) mapping, Rate matching indicator, zero power (ZP) CSI-reference signal (RS) trigger, HARQ ID, etc. If the DCI has DL assignment, the new bit may be added as additional DCI payload. For TCI activation MAC-CE, the new bit may reuse any reserved bit in the R17 unified TCI activation MAC-CE.

For a second case, if the new selected SpCell previously is a deactivated SCell, a new indicator can be added to existing SCell activation MAC-CE to indicate whether the activated SCell is selected as the new SpCell or remains SCell.

For the assumption where each serving cell for CA can be selected as the new SpCell, an issue is whether the serving cell ID for the new PCell should be maintained as 0 as in legacy. One option is where the serving cell ID of PCell does not need to be maintained as 0. For example, if a SCell is selected as the new PCell, the serving cell ID of the SCell may be used as that of the PCell. Another option is where the serving cell ID of PCell is still maintained as 0. Yet another option is where if a SCell is selected as the new PCell, the serving cell IDs of the SCell and the old PCell are implicitly swapped, such that the serving cell ID of the PCell is always 0. In yet another option, every serving cell has original non-zero serving cell ID, e.g. 1-31. When a serving cell is selected as the new PCell, its serving cell ID is overwritten by 0. When the old PCell is not selected as the new PCell, it will use its original non-zero serving cell ID.

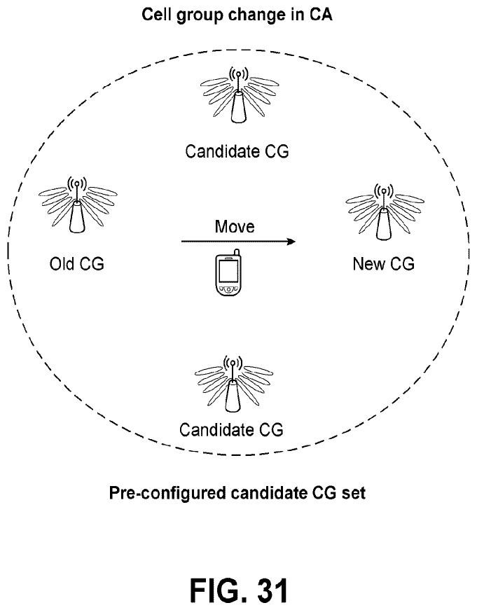

Additionally or alternatively, in some other aspects with reference to FIG. 31, there is another assumption (referred to as Assumption 3) where there is an L1/L2 based cell group (CG) change. In one case according to Assumption 3, if only one CG is allowed to have activated TCI among all candidate CGs, beam indication based SpCell change as in a proposal associated with FIG. 15 can be reused with the following clarification. The CG associated with the candidate SpCell indicated by the latest TCI activation MAC-CE is implicitly selected as the new CG. In another case according to Assumption 3, if only one CG is allowed to have used TCI among all candidate CGs (multiple candidate CGs can have activated TCI), beam indication based SpCell change as in the proposal associated with FIG. 20 can be reused with the following clarification. The CG associated with the candidate SpCell indicated by the latest TCI updating DCI is implicitly selected as the new CG.

Additionally or alternatively, in some other aspects respect to dedicated signaling of a cell and/or beam change, the switching to a new cell may be signaled by dedicated MAC-CE or DCI that at least includes the ID or the new cell, e.g. PCI or serving cell ID. The dedicated MAC-CE or DCI may include other operation parameters for the new cell, including beam indication, TA, PC parameters, active DL and UL BWPs. The same new cell switching command can indicate a new SpCell and/or multiple activated or deactivated SCells with each cell identified by its serving cell ID and indicated for its role, e.g. SpCell or SCell. In case of DCI, the DCI may or may not schedule DL/UL assignment. Dedicated ACK/NACK should be introduced for DCI without DL/UL assignment.

Additionally or alternatively, in some other aspects related to TCI/Cell status of the old cell after a new cell selection, after the application time for the new SpCell, the SpCell functions are moved to the new SpCell, including RACH, system information (SI), radio resource management (RRM), paging, radio link monitoring (RLM), and the TCI/Cell status of the old SpCell may have the following options. In a first option, an active TCI of the old SpCell and/or the old SpCell itself are implicitly deactivated. In a second option, an active TCI of the old SpCell and/or the old SpCell itself can still be implicitly activated, e.g. the old SpCell can be implicitly downgraded as activated SCell, e.g. in case of the assumption associated with FIG. 30. For example, all active TCIs remain activated if total number of active TCIs is within UE capability, including both the TCIs for the old and the new SpCells. Otherwise, prioritization rule can be introduced to determine which subset of active TCI of old SpCell can remain activated, e.g. based on order of configured TCI ID, or the order in TCI activation MAC-CE. In yet another option, the TCI/Cell activation status of the old SpCell is explicitly indicated. For example, the behavior of either the option related to deactivation or the option related to remain activation can be RRC configured or dynamically indicated, e.g. via the cell change command. It is noted that, according to some aspects, in case of CG based change (the assumption associated with FIG. 31), the (de)activation behavior for the old SpCell, e.g. determined by one of the options above, can be extended to all cells in the old CG.

Additionally or alternatively, in some other aspects, in another proposal related to the relation between R17 and R18 inter-cell features. The operation relation between R17 and R18 inter-cell features may have the following options. If R18 serving cell change based mobility is enabled/configured, e.g. for SpCell change, then a first option can be that the R17 inter-cell feature should not be enabled/configured for a cell related to the selected SpCell. Another option is that the R17 inter-cell feature can be enabled/configured for a cell related to the selected SpCell. This can be up to UE capability and/or gNB indication. Note that the cell related to the selected SpCell may include the selected SpCell, any candidate SpCell, any cell in the same cell group as the selected SpCell, any CC sharing the same band as the selected SpCell. The above R17 inter-cell feature includes inter-cell BM and/or inter-cell mTRP.

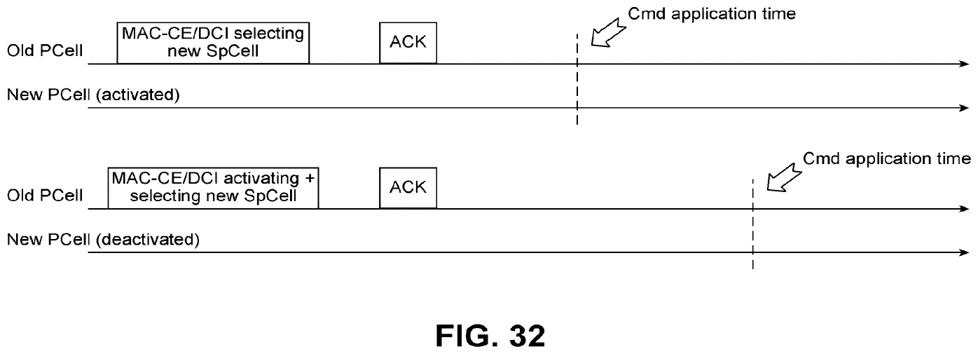

FIG. 32 illustrates the L1/L2 cell change command application time. An example motivation for such an aspect is that the L1/L2 serving cell change command application time, e.g. for SpCell change, may depend on certain factors, such as DCI vs. MAC-CE, new PCell previously activated vs. deactivated, a new single cell vs. new CG, any combination thereof, and/or other factors.

Another proposal related to the L1/L2 cell change command application time can include the application time for each new cell should be specified. In one case, if the new cell is signaled via MAC-CE, the application time may be X millisecond(ms) from the end of UL slot carrying the ACK for the MAC-CE. In another case, if the new cell is signaled via DCI, then one option is that the application time may be the start of first slot after X ms or symbols from the end of UL transmission carrying the ACK for the DCI. In case of X symbols, the SCS and the first slot may be determined based on the SCS of the active DL or UL BWP of the new cell, or the smallest/largest SCS of the active DL and UL BWPs of the new cell. Another option is that the application time may be the start of first slot after X ms or symbols from the end of DCI. In case of X symbols, the SCS and the first slot may be determined based on the SCS of the active DL BWP of the signaling cell, the SCS of the active DL or UL BWP of the new cell, or the smallest/largest SCS of the active DL and UL BWPs of the new cell and the active DL and UL BWPs of the signaling cell.

For both the above cases, the X can be different depending on whether the new cell has been previously activated or not, or previously has activated TCI or not. In case of X symbols, the X can be configured and common per SCS, X per SCS can be configured per DL/UL BWP, X per SCS should be same if the active DL and UL BWPs of the new cell have same SCS, e.g. common X per SCS, or can be different, e.g. common X per DL SCS, and common X per UL SCS and configured X per SCS should be further subject to UE capability, e.g. should be no less than a value indicated by UE capability.

In case of multiple new cells, e.g. in the new CG, a first option can be where each new cell has its own application time. A second option can be where all new cells have a common application time, e.g. as the longest application time of all new cells.

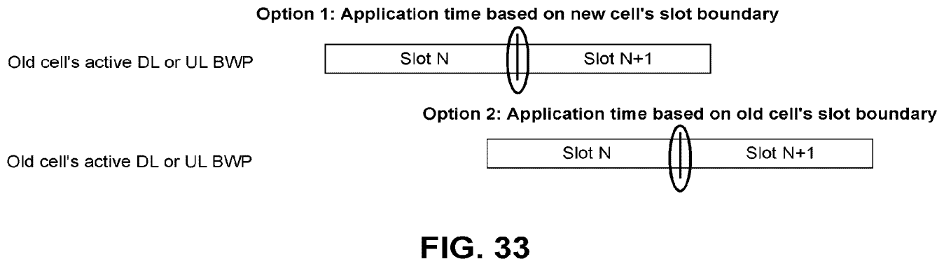

In case the reception timing is greater than CP or different TA for old and new cells, the slot boundary of the application time is one of several options. A first option is that the time is determined by the slot boundary of the new cell, and any transmission/reception on the old cell will be. Another option related to this first option is that the old cell will be error case of dropped if exceeding the application time based on new cell's slot boundary. Another option related to this first option is that the old cell will be prioritized as long as not exceeding the application time based on old cell's slot boundary. A second options is that the application time is determined by the slot boundary of the old cell, and any transmission/reception on the new cell will be either error case or dropped if prior to the application time based on old cell's slot boundary or prioritized as long as not prior to the application time based on new cell's slot boundary. See FIG. 33 with reference to the above proposal.

Another proposal relates to cell switch latency reduction via cell switch command triggered beam management. To reduce TRS tracking and beam refinement latency after cell switch, a MAC-CE or DCI indicating a new cell, SpCell or SCell, may also trigger/activate AP/SP CSI-RS for tracking reference signal, AP/SP CSI-RS in a CSI-RS resource set with repetition ON, or AP/SP CSI-RS for beam/CSI report. MAC-CE or DCI can indicate the ID of AP/SP CSI-RS resource(s) or resource set(s). The scheduling offset from the end of MAC-CE/DCI or its ACK to the start of AP/SP CSI-RS can be RRC configured.

If AP/SP CSI-RS has no explicitly signaled TCI state, the TCI state can be implicitly determined as the indicated joint or separate DL TCI for the new cell in the new cell switch command. If AP/SP CSI-RS has explicit signaled the TCI state: (1) the TCI state can be additionally applied to other DL channels/RSs, e.g. PDCCH, PDSCH, CSI-RS, if the TCI state is DL applicable TCI state, e.g. DL only or joint DL/UL TCI state; or (2) the TCI state can be additionally applied to other DL and UL channels/RSs, e.g. PDCCH, PDSCH, CSI-RS, PUCCH, PUSCH, SRS, PRACH, if the TCI state is DL and UL applicable TCI state, e.g. joint DL/UL TCI state.

Yet another proposal relates to cell switch latency reduction via linkage for known QCL. For example, to save beam training latency after serving cell switch, NW may indicate two CSI-RS resources or two CSI-RS resource sets configured for serving and neighbor cells are resource-wise linked, such that the linked two CSI-RS resources indicate the same UE Rx beam. For example, suppose CSI-RS #1 configured for the new serving cell is linked to the CSI-RS #3 configured for the old serving cell, and NW indicates cell change to the new serving cell with the new TCI with CSI-RS #1 as QCL-TypeD. Based on the linkage, the new TCI with CSI-RS #1 as QCL-TypeD corresponds to the same UE Rx beam indicated by the old TCI with CSI-RS #3 as QCL-TypeD. Based on NW implementation, the CSI-RS #3 configured for the old serving cell can be transmitted by an actual gNB Tx beam same as that for the CSI-RS #1 configured for the new serving cell. Instead of CSI-RS resource or resource set, the linked RRC parameters can be two TCI states or TCI state sets configured for serving and neighbor cells.

Another proposal relates to cell switch latency reduction via TA/BM for deactivated servicing cell. The TA can be measured and signaled to UE for configured serving cell not activated for data/control, e.g. deactivated SCell, which can be candidate cell for new SpCell in L1/L2 based mobility. In R17, RACH cannot be transmitted on deactivated SCell. To speed up the cell switch, RACH can be transmitted and TA command can be updated for configured serving cell not activated for data/control, e.g. deactivated SCell

Another proposal also relates to cell switch latency reduction via TA/BM for deactivated servicing cell. The BFD/RLM can be performed for configured serving cell not activated for data/control, e.g. deactivated SCell, which can be candidate cell for new SpCell in L1/L2 based mobility.

Another proposal further relates to cell switch latency reduction via TA/BM for deactivated servicing cell. In L1/L2 based inter-cell mobility, UE can be pre-configured or pre-indicated with the beam(s) for different channels/RSs of configured serving cell not activated for data/control, e.g. deactivated SCell, which can be candidate cell for new SpCell in L1/L2 based mobility. The pre-indicated/configured beam(s) will be applied implicitly after the candidate cell is selected for use, e.g. as the new SpCell

Another proposal further relates to cell switch latency reduction via TA/BM for deactivated servicing cell. To reduce TRS tracking latency after cell switch, MAC-CE can activate TCI state configured for a candidate cell not selected for use yet. The MAC-CE can be sent from a currently used cell with applied cell ID as the intended candidate cell

The activated TCI(s) per unused candidate cell should be counted in the UE capability on maximum number of active TCI per CC and across CCs in the same band by treating the unused candidate cell as one used serving cell for the UE capability counting purpose

Another proposal further relates to cell switch latency reduction via TA/BM for deactivated servicing cell. To reduce beam refinement latency after cell switch, MAC-CE/DCI can activate/trigger SP/AP CSI-RS resource set with repetition ON configured for a candidate cell not selected for use yet. The DCI can be sent from current serving cell with CIF indicating the intended unused candidate cell. Each CSI-RS resource in the set has TCI state configured for the unused candidate cell.

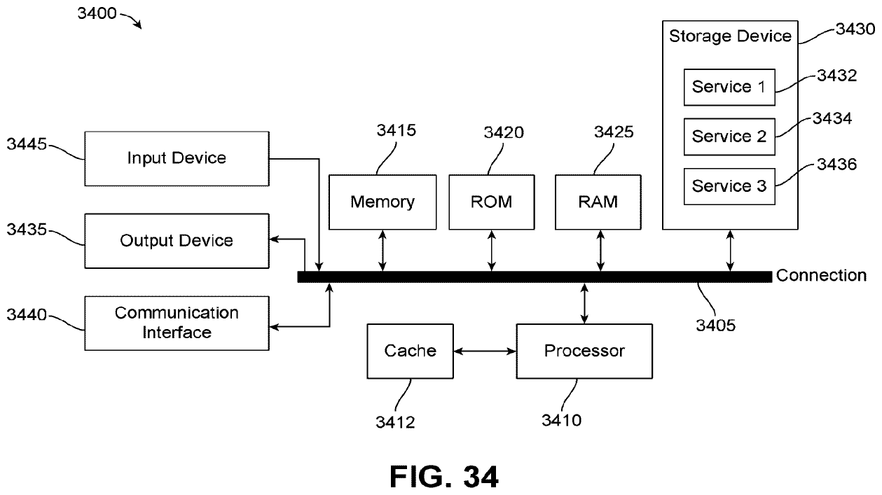

In some examples, the processes described herein may be performed by a computing device or apparatus (e.g., a UE, a network entity, etc.). In one example, the processes described herein may be performed by a wireless communication device, such as a UE (e.g., the UE 407 of FIG. 4, a mobile device, and/or other UE or device). In another example, the processes described herein may be performed by a computing device with the computing system 3400 shown in FIG. 34. For instance, a wireless communication device (e.g., the UE 407 of FIG. 4 and/or other UE or device) with the computing architecture shown in FIG. 34 may include the components of the UE and may implement the operations of the processes described herein.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the WiFi (802.11x) standards, data according to the Bluetooth™ standard, data according to the Internet Protocol (IP) standard, and/or other types of data.

The components of the computing device may be implemented in circuitry. For example, the components may include and/or may be implemented using electronic circuits or other electronic hardware, which may include one or more programmable electronic circuits (e.g., microprocessors, graphics processing units (GPUs), digital signal processors (DSPs), central processing units (CPUs), and/or other suitable electronic circuits), and/or may include and/or be implemented using computer software, firmware, or any combination thereof, to perform the various operations described herein.

The processes described herein may be described or illustrated as logical flow diagrams, the operation of which represent a sequence of operations that may be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations may be combined in any order and/or in parallel to implement the processes.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 34 is a diagram illustrating an example of a system for implementing certain aspects of the present technology. In particular, FIG. 34 illustrates an example of computing system 3400, which may be for example any computing device making up internal computing system, a remote computing system, a camera, or any component thereof in which the components of the system are in communication with each other using connection 3405. Connection 3405 may be a physical connection using a bus, or a direct connection into processor 3410, such as in a chipset architecture. Connection 3405 may also be a virtual connection, networked connection, or logical connection.

In some aspects, computing system 3400 is a distributed system in which the functions described in this disclosure may be distributed within a datacenter, multiple data centers, a peer network, etc. In some aspects, one or more of the described system components represents many such components each performing some or all of the function for which the component is described. In some aspects, the components may be physical or virtual devices.

Example system 3400 includes at least one processing unit (CPU or processor) 3410 and connection 3405 that communicatively couples various system components including system memory 3415, such as read-only memory (ROM) 3420 and random access memory (RAM) 3425 to processor 3410. Computing system 3400 may include a cache 3412 of high-speed memory connected directly with, in close proximity to, or integrated as part of processor 3410.

Processor 3410 may include any general purpose processor and a hardware service or software service, such as services 3432, 3434, and 3436 stored in storage device 3430, configured to control processor 3410 as well as a special-purpose processor where software instructions are incorporated into the actual processor design. Processor 3410 may essentially be a completely self-contained computing system, containing multiple cores or processors, a bus, memory controller, cache, etc. A multi-core processor may be symmetric or asymmetric.

To enable user interaction, computing system 3400 includes an input device 3445, which may represent any number of input mechanisms, such as a microphone for speech, a touch-sensitive screen for gesture or graphical input, keyboard, mouse, motion input, speech, etc. Computing system 3400 may also include output device 3435, which may be one or more of a number of output mechanisms. In some instances, multimodal systems may enable a user to provide multiple types of input/output to communicate with computing system 3400.

Computing system 3400 may include communications interface 3440, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 3440 may also include one or more Global Navigation Satellite System (GNSS) receivers or transceivers that are used to determine a location of the computing system 3400 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 3430 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 3430 may include software services, servers, services, etc., that when the code that defines such software is executed by the processor 3410, it causes the system to perform a function. In some aspects, a hardware service that performs a particular function may include the software component stored in a computer-readable medium in connection with the necessary hardware components, such as processor 3410, connection 3405, output device 3435, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B.

Illustrative Aspects of the disclosure include:

Aspect 1. An apparatus for wireless communications, comprising: at least one memory comprising instructions; and at least one processor coupled to the at least one memory and configured to: select a special cell (SpCell) from one or more candidate cells for communicating with a user equipment (UE); and transmit an indication of the SpCell to the UE.

Aspect 2. The apparatus of Aspect 1, wherein the one or more candidate cells correspond to a subset of serving cells configured to communicate with the UE.

Aspect 3. The apparatus of any of Aspects 1 to 2, wherein the one or more candidate cells correspond to one or more serving cells included in at least one cell group associated with the UE.

Aspect 4. The apparatus of any of Aspects 1 to 3, wherein the indication corresponds to a beam indication, and wherein the beam indication includes at least one of a layer 1 (L1) downlink control information (DCI) beam indication and a layer 2 (L2) media access control (MAC) control element (CE) beam indication.

Aspect 5. The apparatus of Aspect 4, wherein the beam indication includes a transmission configuration indicator (TCI) codepoint corresponding to at least one of a first TCI state for an uplink direction and a second TCI state for a downlink direction.

Aspect 6. The apparatus of any of Aspects 1 to 5, wherein the indication corresponds to a cell switch command.

Aspect 7. The apparatus of Aspect 6, wherein the cell switch command is signaled using at least one of a MAC-CE and a DCI.

Aspect 8. The apparatus of Aspect 7, wherein the DCI includes at least one of a downlink scheduling assignment corresponding to a physical downlink shared channel (PDSCH) and an uplink scheduling assignment corresponding to a physical uplink shared channel (PUSCH).

Aspect 9. The apparatus of any of Aspects 6 to 8, wherein the cell switch command includes an identifier corresponding to the SpCell.

Aspect 10. The apparatus of any of Aspects 6 to 9, wherein the cell switch command includes one or more identifiers corresponding to one or more secondary cells.

Aspect 11. The apparatus of any of Aspects 1 to 10, wherein the cell switch command includes at least one of a beam indication, a timing advance (TA) value, a power control parameter, a downlink bandwidth part (BWP), and an uplink BWP.

Aspect 12. The apparatus of any of Aspects 6 to 11, wherein the cell switch command includes one or more transmission configuration indicators (TCIs) corresponding to one or more transmit receive points (TRPs) associated with the SpCell.

Aspect 13. The apparatus of any of Aspects 6 to 12, wherein the cell switch command includes at least one transmission configuration indicator (TCI) corresponding to at least one of the SpCell and one or more secondary cells (SCells).

Aspect 14. The apparatus of any of Aspects 1 to 13, wherein the indication includes an application time for the UE to switch to the SpCell.

Aspect 15. The apparatus of Aspect 14, wherein the application time corresponds to a threshold time from an end of an uplink slot that includes an acknowledgment (ACK) to the indication, wherein the indication corresponds to a MAC-CE.

Aspect 16. The apparatus of Aspect 14, wherein the application time corresponds to a slot occurring a threshold time after an ACK to the indication, wherein the indication corresponds to a DCI.

Aspect 17. The apparatus of Aspect 16, wherein the threshold time corresponds a threshold number of symbols.

Aspect 18. The apparatus of Aspect 17, wherein a subcarrier spacing (SCS) parameter included in the indication is at least one of a first SCS value corresponding to an active downlink BWP of the SpCell, a second SCS value corresponding to an active uplink BWP of the SpCell, a third SCS value corresponding to a smallest SCS associated with an active downlink BWP of the SpCell, a fourth SCS value corresponding to a largest SCS associated with an active downlink BWP of the SpCell, a fifth SCS value corresponding to a smallest SCS associated with an active uplink BWP of the SpCell, and a sixth SCS value corresponding to a largest SCS associated with an active uplink BWP of the SpCell.

Aspect 19. The apparatus of Aspect 14, wherein the application time corresponds to a slot occurring a threshold time from the indication, wherein the indication corresponds to a DCI.

Aspect 20. The apparatus of Aspect 19, wherein the threshold time corresponds a threshold number of symbols.

Aspect 21. The apparatus of Aspect 20, wherein a subcarrier spacing (SCS) parameter included in the indication is at least one of a first SCS value corresponding to an active downlink BWP of the apparatus, a second SCS value corresponding to an active downlink BWP of the SpCell, a third SCS value corresponding to an active uplink BWP of the SpCell, a fourth SCS value corresponding to a smallest SCS associated with an active downlink BWP of the SpCell, a fifth SCS value corresponding to a largest SCS associated with an active downlink BWP of the SpCell, a sixth SCS value corresponding to a smallest SCS associated with an active uplink BWP of the SpCell, a seventh SCS value corresponding to a largest SCS associated with an active uplink BWP of the SpCell, an eight SCS value corresponding to a smallest SCS associated with an active downlink BWP of the apparatus, a ninth SCS value corresponding to a largest SCS associated with an active downlink BWP of the apparatus, a tenth SCS value corresponding to a smallest SCS associated with an active uplink BWP of the apparatus, and an eleventh SCS value corresponding to a largest SCS associated with an active uplink BWP of the apparatus.

Aspect 22. The apparatus of Aspect 14, wherein the application time is based on an activation status of the SpCell.

Aspect 23. The apparatus of Aspect 14, wherein the application time corresponds to a threshold number of symbols, and wherein the threshold number of symbols is based on a capability of the UE.

Aspect 24. The apparatus of Aspect 14, wherein the application time corresponds to a threshold number of symbols, and wherein the threshold number of symbols is based on a subcarrier spacing (SCS).

Aspect 25. The apparatus of Aspect 14, wherein the application time corresponds to a common application time for the UE to switch to a plurality of new cells.

Aspect 26. The apparatus of Aspect 25, wherein the common application time is based on a longest time for the UE to switch to at least one candidate cell from the one or more candidate cells.

Aspect 27. The apparatus of Aspect 14, wherein a slot boundary corresponding to the application time is based on a first slot timing corresponding to the SpCell, wherein the first slot timing corresponding to the SpCell is different from a second slot timing corresponding to a prior serving cell.

Aspect 28. The apparatus of Aspect 27, wherein the UE is configured to discard communications occurring after the slot boundary.

Aspect 29. The apparatus of Aspect 27, wherein the UE is configured to process communications occurring prior to an expiration of the application time based on the second slot timing.

Aspect 30. The apparatus of Aspect 14, wherein a slot boundary corresponding to the application time is based on a first slot timing corresponding to a prior serving cell, wherein the first slot timing corresponding to the prior serving cell is different from a second slot timing corresponding to the SpCell.

Aspect 31. The apparatus of Aspect 30, wherein the UE is configured to discard communications occurring after the slot boundary.

Aspect 32. The apparatus of Aspect 30, wherein the UE is configured to process communications occurring prior to an expiration of the application time based on the second slot timing.

Aspect 33. The apparatus of any of Aspects 1 to 32, wherein the indication configures the UE to perform one or more measurements associated with the SpCell.

Aspect 34. The apparatus of Aspect 33, wherein the one or more measurements include at least one of an aperiodical (AP) channel state information reference signal (CSI-RS) measurement, a semi-persistent (SP) CSI-RS measurement, an AP tracking resource signal (TRS) measurement, and an SP TRS measurement.

Aspect 35. The apparatus of Aspect 34, wherein the AP CSI-RS measurement and the SP CSI-RS measurement correspond to a CSI-RS resource set with repetition enabled.

Aspect 36. The apparatus of Aspect 34, wherein the AP CSI-RS measurement and the SP CSI-RS measurement correspond to at least one of a beam report and a CSI report.

Aspect 37. The apparatus of Aspect 34, wherein the indication includes an identifier of a CSI-RS resource set.

Aspect 38. The apparatus of any of Aspects 33 to 37, further comprising: configuring, using radio resource control (RRC), a scheduling offset corresponding to a start of the one or more measurements, wherein the scheduling offset is relative to at least one of an end of the indication and an acknowledgment (ACK) corresponding to the indication.

Aspect 39. The apparatus of any of Aspects 33 to 38, further comprising: determining a transmission configuration indicator (TCI) state corresponding to a CSI-RS, wherein the indication includes the TCI state.

Aspect 40. The apparatus of Aspect 39, wherein the TCI state corresponds to a downlink TCI associated with the SpCell.

Aspect 41. The apparatus of any of Aspects 1 to 40, further comprising: transmitting a first resource identifier corresponding to a first resource associated with the SpCell and a second resource identifier corresponding to a second resource associated with a neighboring cell, wherein the first resource and the second resource share one or more downlink resources.

Aspect 42. The apparatus of Aspect 41, wherein the first resource and the second resource correspond to a CSI-RS.

Aspect 43. The apparatus of any of Aspects 1 to 42, further comprising: transmitting one or more linked radio resource control (RRC) parameters to the UE, wherein the one or more linked RRC parameters are associated with the SpCell and at least one neighboring cell.

Aspect 44. The apparatus of Aspect 43, wherein the one or more linked RRC parameters include at least one of one or more transmission configuration indicator (TCI) states and one or more TCI state sets.

Aspect 45. The apparatus of any of Aspects 1 to 44, further comprising: determining a timing advance (TA) parameter associated with a deactivated secondary cell that is part of the one or more candidate cells; and transmitting the TA parameter to the UE.

Aspect 46. The apparatus of any of Aspects 1 to 45, further comprising: transmitting, to the UE, beam configuration information corresponding to at least a portion of the one or more candidate cells.

Aspect 47. The apparatus of any of Aspects 1 to 46, further comprising: transmitting, to the UE, an instruction to activate a transmission configuration indicator (TCI) state for at least one candidate cell from the one or more candidate cells.

Aspect 48. The apparatus of Aspect 47, wherein the instruction corresponds to a media access control (MAC) control element (CE).

Aspect 49. The apparatus of any of Aspects 1 to 48, further comprising: transmitting, to the UE, an instruction to activate an aperiodical CSI-RS resource set with repetition enabled for at least one candidate cell from the one or more candidate cells.

Aspect 50. The apparatus of Aspect 49, wherein the instruction corresponds to a downlink control information (DCI).

Aspect 51. The apparatus of Aspect 50, wherein the DCI includes a carrier indicator field (CIF) that identifies the at least one candidate cell.

Aspect 52. The apparatus of any of Aspects 1 to 51, wherein the apparatus is configured as a network entity.

Aspect 53. An apparatus for wireless communications, comprising: at least one memory comprising instructions; and at least one processor configured to: receive an indication of a special cell (SpCell) from a network entity; and in response to the indication, communicate with the SpCell.

Aspect 54. The apparatus of Aspect 53, wherein the indication corresponds to a beam indication, and wherein the beam indication includes at least one of a layer 1 (L1) downlink control information (DCI) beam indication and a layer 2 (L2) media access control (MAC) control element (CE) beam indication.

Aspect 55. The apparatus of Aspect 54, wherein the beam indication includes a transmission configuration indicator (TCI) codepoint corresponding to at least one of a first TCI state for an uplink direction and a second TCI state for a downlink direction.

Aspect 56. The apparatus of any of Aspects 53 to 55, wherein the indication corresponds to a cell switch command.

Aspect 57. The apparatus of Aspect 56, wherein the cell switch command is signaled using at least one of a MAC-CE and a DCI.

Aspect 58. The apparatus of Aspect 57, wherein the DCI includes at least one of a downlink scheduling assignment corresponding to a physical downlink shared channel (PDSCH) and an uplink scheduling assignment corresponding to a physical uplink shared channel (PUSCH).

Aspect 59. The apparatus of any of Aspects 56 to 58, wherein the cell switch command includes an identifier corresponding to the SpCell.

Aspect 60. The apparatus of any of Aspects 56 to 59, wherein the cell switch command includes one or more identifiers corresponding to one or more secondary cells.

Aspect 61. The apparatus of any of Aspects 56 to 60, wherein the cell switch command includes at least one of a beam indication, a timing advance (TA) value, a power control parameter, a downlink bandwidth part (BWP), and an uplink BWP.

Aspect 62. The apparatus of any of Aspects 56 to 61, wherein the cell switch command includes one or more transmission configuration indicators (TCIs) corresponding to one or more transmit receive points (TRPs) associated with the SpCell.

Aspect 63. The apparatus of any of Aspects 56 to 62, wherein the cell switch command includes at least one transmission configuration indicator (TCI) corresponding to at least one of the SpCell and one or more secondary cells (SCells).

Aspect 64. The apparatus of any of Aspects 53 to 63, wherein the indication includes an application time for the apparatus to switch to the SpCell.

Aspect 65. The apparatus of Aspect 64, wherein the application time corresponds to a threshold time from an end of an uplink slot that includes an acknowledgment (ACK) to the indication, wherein the indication corresponds to a MAC-CE.

Aspect 66. The apparatus of any of Aspect 64, wherein the application time corresponds to a slot occurring a threshold time after an ACK to the indication, wherein the indication corresponds to a DCI.

Aspect 67. The apparatus of Aspect 66, wherein the threshold time corresponds a threshold number of symbols.

Aspect 68. The apparatus of Aspect 67, wherein a subcarrier spacing (SCS) parameter included in the indication is at least one of a first SCS value corresponding to an active downlink BWP of the SpCell, a second SCS value corresponding to an active uplink BWP of the SpCell, a third SCS value corresponding to a smallest SCS associated with an active downlink BWP of the SpCell, a fourth SCS value corresponding to a largest SCS associated with an active downlink BWP of the SpCell, a fifth SCS value corresponding to a smallest SCS associated with an active uplink BWP of the SpCell, and a sixth SCS value corresponding to a largest SCS associated with an active uplink BWP of the SpCell.

Aspect 69. The apparatus of Aspect 64, wherein the application time corresponds to a slot occurring a threshold time from the indication, wherein the indication corresponds to a DCI.

Aspect 70. The apparatus of Aspect 69, wherein the threshold time corresponds a threshold number of symbols.

Aspect 71. The apparatus of Aspect 70, wherein a subcarrier spacing (SCS) parameter included in the indication is at least one of a first SCS value corresponding to an active downlink BWP of the apparatus, a second SCS value corresponding to an active downlink BWP of the SpCell, a third SCS value corresponding to an active uplink BWP of the SpCell, a fourth SCS value corresponding to a smallest SCS associated with an active downlink BWP of the SpCell, a fifth SCS value corresponding to a largest SCS associated with an active downlink BWP of the SpCell, a sixth SCS value corresponding to a smallest SCS associated with an active uplink BWP of the SpCell, a seventh SCS value corresponding to a largest SCS associated with an active uplink BWP of the SpCell, an eight SCS value corresponding to a smallest SCS associated with an active downlink BWP of the apparatus, a ninth SCS value corresponding to a largest SCS associated with an active downlink BWP of the apparatus, a tenth SCS value corresponding to a smallest SCS associated with an active uplink BWP of the apparatus, and an eleventh SCS value corresponding to a largest SCS associated with an active uplink BWP of the apparatus.

Aspect 72. The apparatus of Aspect 64, wherein the application time is based on an activation status of the SpCell.

Aspect 73. The apparatus of Aspect 64, wherein the application time corresponds to a threshold number of symbols, and wherein the threshold number of symbols is based on a capability of the apparatus.

Aspect 74. The apparatus of any of Aspects 53 to 73, wherein the application time corresponds to a threshold number of symbols, and wherein the threshold number of symbols is based on a subcarrier spacing (SCS).

Aspect 75. The apparatus of Aspect 64, wherein the application time corresponds to a common application time for the apparatus to switch to a plurality of new cells.

Aspect 76. The apparatus of Aspect 75, wherein the common application time is based on a longest time for the apparatus to switch to at least one candidate cell from one or more candidate cells.

Aspect 77. The apparatus of Aspect 64, wherein a slot boundary corresponding to the application time is based on a first slot timing corresponding to the SpCell, wherein the first slot timing corresponding to the SpCell is different from a second slot timing corresponding to a prior serving cell.

Aspect 78. The apparatus of Aspect 77, wherein the apparatus is configured to discard communications occurring after the slot boundary.

Aspect 79. The apparatus of Aspect 77, wherein the apparatus is configured to process communications occurring prior to an expiration of the application time based on the second slot timing.

Aspect 80. The apparatus of Aspect 64, wherein a slot boundary corresponding to the application time is based on a first slot timing corresponding to a prior serving cell, wherein the first slot timing corresponding to the prior serving cell is different from a second slot timing corresponding to the SpCell.

Aspect 81. The apparatus of Aspect 80, wherein the apparatus is configured to discard communications occurring after the slot boundary.

Aspect 82. The apparatus of Aspect 80, wherein the apparatus is configured to process communications occurring prior to an expiration of the application time based on the second slot timing.

Aspect 83. The apparatus of any of Aspects 53 to 82, wherein the indication configures the apparatus to perform one or more measurements associated with the SpCell.

Aspect 84. The apparatus of Aspect 83, wherein the one or more measurements include at least one of an aperiodical (AP) channel state information reference signal (CSI-RS) measurement, a semi-persistent (SP) CSI-RS measurement, an AP tracking resource signal (TRS) measurement, and an SP TRS measurement.

Aspect 85. The apparatus of Aspect 84, wherein the AP CSI-RS measurement and the SP CSI-RS measurement correspond to a CSI-RS resource set with repetition enabled.

Aspect 86. The apparatus of Aspect 84, wherein the AP CSI-RS measurement and the SP CSI-RS measurement correspond to at least one of a beam report and a CSI report.

Aspect 87. The apparatus of Aspect 84, wherein the indication includes an identifier of a CSI-RS resource set.

Aspect 88. The apparatus of any of Aspects 83 to 87, further comprising: receiving, via radio resource control (RRC), a scheduling offset corresponding to a start time of the one or more measurements, wherein the scheduling offset is relative to at least one of an end of the indication and an acknowledgment (ACK) corresponding to the indication.

Aspect 89. The apparatus of any of Aspects 83 to 88, further comprising: receiving a transmission configuration indicator (TCI) state corresponding to a CSI-RS associated with the one or more measurements.

Aspect 90. The apparatus of Aspect 89, wherein the TCI state corresponds to a downlink TCI associated with the SpCell.

Aspect 91. The apparatus of any of Aspects 53 to 90, further comprising: receiving a first resource identifier corresponding to a first resource associated with the SpCell and a second resource identifier corresponding to a second resource associated with a neighboring cell, wherein the first resource and the second resource share one or more downlink resources.

Aspect 92. The apparatus of Aspect 91, wherein the first resource and the second resource correspond to a CSI-RS.

Aspect 93. The apparatus of any of Aspects 53 to 92, further comprising: receiving one or more linked radio resource control (RRC) parameters, wherein the one or more linked RRC parameters are associated with the SpCell and at least one neighboring cell.

Aspect 94. The apparatus of Aspect 93, wherein the one or more linked RRC parameters include at least one of one or more transmission configuration indicator (TCI) states and one or more TCI state sets.

Aspect 95. The apparatus of any of Aspects 53 to 94, further comprising: receiving a timing advance (TA) parameter associated with a deactivated secondary cell that is part of one or more candidate cells; and transmitting, based on the TA parameter, a random access channel (RACH) message to the deactivated secondary cell.

Aspect 96. The apparatus of any of Aspects 53 to 95, further comprising: receiving a message identifying one or more deactivated secondary cells; and performing at least one of beam failure detection and radio link monitoring with at least one deactivated secondary cell from the one or more deactivated secondary cells.

Aspect 97. The apparatus of any of Aspects 53 to 96, further comprising: receiving beam configuration information corresponding to one or more candidate cells.

Aspect 98. The apparatus of Aspect 97, further comprising: transmitting a signal to the SpCell based on the beam configuration information.

Aspect 99. The apparatus of any of Aspects 53 to 98, further comprising: receiving an instruction to activate a transmission configuration indicator (TCI) state for at least one candidate cell from one or more candidate cells.

Aspect 100. The apparatus of Aspect 99, wherein the instruction corresponds to a media access control (MAC) control element (CE).

Aspect 101. The apparatus of any of Aspects 53 to 100, further comprising: receiving an instruction to activate an aperiodical CSI-RS resource set with repetition enabled for at least one candidate cell from one or more candidate cells.

Aspect 102. The apparatus of Aspect 101, wherein the instruction corresponds to a downlink control information (DCI).

Aspect 103. The apparatus of Aspect 102, wherein the DCI includes a carrier indicator field (CIF) that identifies the at least one candidate cell.

Aspect 104. The apparatus of any of Aspects 53 to 103, wherein the apparatus is configured as a user equipment (UE).

Aspect 105. A method of wireless communications at a network entity, the method comprising operations according to any of Aspects 1 to 52.

Aspect 106. A method of wireless communications at a user equipment (UE), the method comprising operations according to any of Aspects 53 to 104.

Aspect 107. A non-transitory computer-readable medium of a network entity is provided that includes stored thereon at least one instruction that, when executed by one or more processors, may cause the one or more processors to perform operations according to any of Aspect 1 to 52.

Aspect 108. A non-transitory computer-readable medium of a user equipment (UE) is provided that includes stored thereon at least one instruction that, when executed by one or more processors, may cause the one or more processors to perform operations according to any of Aspect 53 to 104.

Aspect 109. An apparatus for wireless communications, comprising one or more means for performing operations according to any of Aspect 1 to 52.

Aspect 110. An apparatus for wireless communications, comprising one or more means for performing operations according to any of Aspect 53 to 104.

Aspect 111. An apparatus for wireless communications, comprising: at least one memory comprising instructions; and at least one processor coupled to the at least one memory and configured to: receive, from a first special cell (SpCell), a beam indication or activation command via a medium access control-control element (MAC-CE) or a downlink control element (DCI); and in response to the beam indication or activation command, determine a second SpCell for communication.

Aspect 112. The apparatus of Aspect 111, wherein the second SpCell is implied by the MAC-CE based on the MAC-CE activating at least one Transmission Configuration Indicator (TCI) state configured for the second SpCell.

Aspect 113. The apparatus of any of Aspects 111 or 112, wherein the second SpCell is implied by the MAC-CE or the DCI based on the MAC-CE or the DCI indicating to the apparatus to use at least one Transmission Configuration Indicator (TCI) state configured to the second SpCell.

Aspect 114. The apparatus of any of Aspects 111 to 113, wherein the beam indication or activation command comprises an indicator added to a Transmission Configuration Indicator (TCI) activation MAC-CE or a TCI updating downlink control information (DCI) to indicate whether a serving cell indicated by a serving cell identifier (ID) field of the MAC-CE or in a carrier indicator field (CIF) of the DCI is selected as the second SpCell or remains as the serving cell.

Aspect 115. The apparatus of any of Aspects 111 to 114, wherein the beam indication or activation command comprises a Transmission Configuration Indicator (TCI) activation MAC-CE indicating a cell group associated with the second SpCell, and wherein the cell group associated with the second SpCell is implicitly selected as a new cell group.

Aspect 116. The apparatus of any of Aspects 111 to 115, wherein the beam indication or activation command comprises a PCI or serving cell ID.

Aspect 117. The apparatus of any of Aspects 111 to 116, wherein the at least one processor is configured to: transfer one or more functions of the first SpCell to the second SpCell.

Aspect 118. The apparatus of Aspect 117, wherein the one or more functions of first SpCell comprise at least one of RACH, SI, RRM, paging, or RLMS.

Aspect 119. The apparatus of any of Aspects 111 or 118, wherein a Transmission Configuration Indicator (TCI) status or Cell status of the first SpCell when starting to communicate with the second SpCell comprises at least one of: an active TCI of at least one of the first SpcCell or the second SpCell are implicitly deactivated; an active CTI of at least one of the first SpCell or the second SpCell is implicitly activated; or a TCI activation status or Cell activation status of the first SpCell is explicitly indicated.

Aspect 120. The apparatus of any of Aspects 111 to 119, wherein a serving cell change based mobility setting is enabled for a cell related to the second SpCell, and wherein an inter-cell feature is not enabled or configured to a cell related to the second SpCell or the inter-cell feature is enabled for the cell related to the second SpCell.

Aspect 121. The apparatus of any of Aspects 111 to 120, wherein the second SpCell is signaled via the MAC-CE, and wherein an application time for the second SpCell is a set time from an end of an uplink slot carrying an acknowledgement (ACK) for the MAC-CE.

Aspect 122. The apparatus of any of Aspects 111 to 121, wherein the second SpCell is signaled via the DCI, and wherein an application time for the second SpCell is one of a start of a first slot after a set time or a number of symbols from an end of an uplink transmission carrying an acknowledgement (ACK) for the DCI, or a start of a first slot after the set time or the number of symbols from an end of the DCI.

Aspect 123. The apparatus of any of Aspects 111 to 122, wherein the at least one processor is configured to: activate an aperiodic or semi-persistent channel state information reference signal (CSI-RS) or a tracking reference signal (TRS), an aperiodic or semi-persistent CSI-RS in a CSI-RS resource set with repetition on, or an aperiodic or semi-persistent CSI-RS for a beam or CSI report.

Aspect 124. The apparatus of any of Aspects 111 to 123, wherein the at least one processor is configured to: receive a first channel state information reference signal (CSI-RS) resource or resource set configured for a serving cell and a second CSI-RS resource or resource set configured for a neighbor cell, wherein the first CSI-RS resource or resource set and the second CSI-RS resource or resource set are resource-wise linked to indicate a same user equipment receive beam.

Aspect 125. The apparatus of any of Aspects 111 to 124, wherein the at least one processor is configured to: receive a measured and signaled timing advance (TA) for a configured serving cell not activated for data or control, wherein the configured serving cell is a candidate cell for the second SpCell.

Aspect 126. The apparatus of any of Aspects 111 to 125, wherein at least one of beam failure detection (BFD) or radio link monitoring (RLM) is performed for a configured serving cell not activated for data or control, wherein the configured serving cell is a candidate cell for the second SpCell.

Aspect 127. The apparatus of any of Aspects 111 to 126, wherein the apparatus is pre-configured or pre-indicated with one or more beams for different channels or reference signals of a configured serving cell not activated for data or control wherein the configured serving cell is a candidate cell for the second SpCell.

Aspect 128. The apparatus of any of Aspects 111 to 127, the MAC-CE activates a Transmission Configuration Indicator (TCI) state configured for a candidate cell not selected for use to reduce tracking reference signal (TRS) tracking latency after the apparatus starts to communicate with the second SpCell.

Aspect 129. The apparatus of any of Aspects 111 to 128, wherein the MAC-CE or DCI activates or triggers an aperiodic or semi-persistent channel state information reference signal (CSI-RS) resource set with repetition on configured to a candidate cell not selected for use to reduce tracking reference signal (TRS) tracking latency after the apparatus starts to communicate with the second SpCell.

Aspect 130. A method of wireless communications at a user equipment (UE), the method comprising operations according to any of claims 111 to 129.

Aspect 131. A non-transitory computer-readable medium of a network entity is provided that includes stored thereon at least one instruction that, when executed by one or more processors, may cause the one or more processors to perform operations according to any of claims 111 to 129.

Aspect 132. An apparatus for wireless communications, comprising one or more means for performing operations according to any of claims 111 to 129.

1-132. (canceled)

133. An apparatus for wireless communications, comprising:
at least one memory; and
at least one processor coupled to the at least one memory and configured to:
receive, from a serving cell, a cell switching medium access control-control element (MAC-CE) comprising a cell switching command, wherein the cell switching command comprises a cell identifier (ID), a beam indication, and a timing advance (TA) command; and
in response to the cell switching command, determine a candidate cell for communication.

134. The apparatus of claim 133, wherein the cell switching command comprises an indicator to indicate whether a serving cell indicated by a serving cell identifier (ID) field of the cell switching MAC-CE is selected as the candidate cell or remains as the serving cell.

135. The apparatus of claim 133, wherein the cell switching command comprises a physical cell identifier (PCI) or serving cell ID.

136. The apparatus of claim 133, wherein a Transmission Configuration Indicator (TCI) status when starting to communicate with the candidate cell comprises an indication that an active TCI of the serving cell is implicitly deactivated.

137. The apparatus of claim 133, wherein the candidate cell is signaled via the cell switching MAC-CE, and wherein an application time for the candidate cell is a set time from an end of an uplink slot carrying an acknowledgement (ACK) for the MAC-CE.

138. The apparatus of claim 133, wherein the serving cell is a first special cell (SpCell) and the candidate cell is a second SpCell.

139. The apparatus of claim 133, wherein the at least one processor is configured to:
receive an additional MAC-CE; and
based on the additional MAC-CE, activate an aperiodic or semi-persistent channel state information reference signal (CSI-RS) or a tracking reference signal (TRS), an aperiodic or semi-persistent CSI-RS in a CSI-RS resource set with repetition on, or an aperiodic or semi-persistent CSI-RS for a beam or CSI report.

140. The apparatus of claim 133, wherein the cell switching MAC-CE further comprises a measured and signaled TA command for a configured serving cell not activated for data or control, and wherein the configured serving cell is the candidate cell or an additional candidate cell.

141. The apparatus of claim 133, wherein the apparatus is pre-configured or pre-indicated via radio resource control (RRC) signaling with one or more beams for different channels or reference signals of a configured serving cell not activated for data or control, and wherein the configured serving cell is the candidate cell or an additional candidate cell.

142. The apparatus of claim 133, wherein the at least one processor is configured to:
receive a Transmission Configuration Indicator (TCI) activation MAC-CE, wherein the TCI activation MAC-CE activates a TCI state configured for a candidate cell not selected for use to reduce tracking reference signal (TRS) tracking latency after the apparatus starts to communicate with the candidate cell.

143. A method of wireless communications at a user equipment (UE), the method comprising:
receiving, from a serving cell, a cell switching medium access control-control element (MAC-CE) comprising a cell switching command, wherein the cell switching command comprises a cell identifier (ID), a beam indication, and a timing advance (TA) command; and
in response to the cell switching command, determining a candidate cell for communication.

144. The method of claim 143, wherein the cell switching command comprises an indicator to indicate whether a serving cell indicated by a serving cell identifier (ID) field of the cell switching MAC-CE is selected as the candidate cell or remains as the serving cell.

145. The method of claim 143, wherein the cell switching command comprises a physical cell identifier (PCI) or serving cell ID.

146. The method of claim 143, wherein a Transmission Configuration Indicator (TCI) status when starting to communicate with the candidate cell comprises an indication that an active TCI of the serving cell is implicitly deactivated.

147. The method of claim 143, wherein the candidate cell is signaled via the cell switching MAC-CE, and wherein an application time for the candidate cell is a set time from an end of an uplink slot carrying an acknowledgement (ACK) for the MAC-CE.

148. The method of claim 143, wherein the serving cell is a first special cell (SpCell) and the candidate cell is a second SpCell.

149. The method of claim 143, further comprising:
receiving an additional MAC-CE; and
based on the additional MAC-CE, activating an aperiodic or semi-persistent channel state information reference signal (CSI-RS) or a tracking reference signal (TRS), an aperiodic or semi-persistent CSI-RS in a CSI-RS resource set with repetition on, or an aperiodic or semi-persistent CSI-RS for a beam or CSI report.

150. The method of claim 143, wherein the cell switching MAC-CE further comprises a measured and signaled TA command for a configured serving cell not activated for data or control, and wherein the configured serving cell is the candidate cell or an additional candidate cell.

151. The method of claim 143, wherein the UE is pre-configured or pre-indicated via radio resource control (RRC) signaling with one or more beams for different channels or reference signals of a configured serving cell not activated for data or control wherein the configured serving cell is the candidate cell or an additional candidate cell.

152. The method of claim 143, further comprising:
receiving a Transmission Configuration Indicator (TCI) activation MAC-CE, wherein the TCI activation MAC-CE activates a TCI state configured for a candidate cell not selected for use to reduce tracking reference signal (TRS) tracking latency after the UE starts to communicate with the candidate cell.
